(19) United States
(12) Patent Application Publication
(10) Pub. No.: US 2018/0293553 A1
(43) Pub. Date: Oct. 11, 2018

(54) ACCOUNT PLATFORM FOR A DISTRIBUTED NETWORK OF NODES

(71) Applicant: STRONGHOLD LABS, LLC, Chicago, IL (US)

(72) Inventors: Ron Samuel DEMBO, Toronto (CA); Alexander LIPTON, Chicago, IL (US); Sergei BURKOV, Palo Alto, CA (US)

(21) Appl. No.: 15/946,381

(22) Filed: Apr. 5, 2018

Related U.S. Application Data
(60) Provisional application No. 62/482,446, filed on Apr. 6, 2017.

(51) Int. Cl. G06Q 20/02; G06Q 20/38; G06Q 20/06

(52) U.S. Cl. CPC G06Q 20/027; H04L 67/10; G06Q 20/06; G06Q 20/381

(57) ABSTRACT

Embodiments described herein relate to a network of bank nodes to transfer funds to different central bank systems. An account platform generates and record blocks on a distributed block chain across computing devices to create a ledger of transaction records. The bank nodes connect directly to central-bank systems for deposit and withdraw transactions. The account platform is configured to output dynamic bank and customer records using data elements of the distributed ledger.

### FIELD

The improvements generally relate to the field of banking systems and distributed networks.

### INTRODUCTION

A central bank, reserve bank, or monetary authority is an institution that manages a nation's currency, money supply, and interest rates. Central banks can oversee the commercial banking system of their respective countries. In contrast to a commercial bank, a central bank possesses a monopoly on increasing the physical monetary base in the nation, and can print the national currency.

### SUMMARY

In accordance with an aspect, there is provided a network of bank nodes and an account platform with features described herein.

In accordance with an aspect, there is provided a network of bank nodes to transfer funds to central bank systems, and an account platform to generate data elements of transactions and record the data elements of transactions on a distributed ledger provided by a computing devices, the account platform is configured to generate and output dynamic customer records using the distributed ledger. The data elements can be linked with customer identifiers. For example, a transaction is associated with a customer with a corresponding customer identifier. The data element for the transaction is linked to the customer identifier.

There may be multiple data elements linked to the customer identifier. The account platform is configured to generate, in real time, the dynamic customer record using the customer identifier to compile all data elements linked to the customer identifier or otherwise relevant to the customer.

In accordance with one aspect, there is provided an account platform to transfer electronic funds between bank nodes and generate dynamic customer account records using a distributed ledger.

In accordance with an aspect, there is provided a network with a plurality of bank nodes, each bank node connected to a corresponding central bank system to transmit fund transfer commands to trigger a transaction exchange; an account platform having non-transitory computer-readable storage medium with computer-executable instructions for causing a processor to generate transaction data elements and record the transaction data elements on a plurality of ledger nodes, each ledger node comprising at least one computing device, the account platform connecting to the plurality of bank nodes to receive transaction notifications relating to the fund transfer commands, the account platform being configured to maintain and update a distributed ledger by creating block data structures for transactions using the ledger nodes for transaction management, each block data structure indicating a customer identifier for use in generating a dynamic customer record by aggregating block data structures indicating the customer identifier; and an interface for displaying visual representations corresponding to the dynamic customer record.

In some embodiments, a first bank node of the plurality of bank nodes is configured to: generate a first fund transfer command indicating a first customer identifier, a second customer identifier, and a transaction amount; and transmit a transaction notification to the account platform; wherein the account platform is configured to: generate a block data structure indicating the first customer identifier, the second customer identifier, and the transaction amount; and update the distributed ledger with the block data structure to provide notification to the other of the plurality of bank nodes.

In some embodiments, the first bank node is configured to transmit the first fund transfer command to a central bank system to trigger transfer of the transaction amount between an account linked to the first customer identifier and an account linked to the second customer identifier.

In some embodiments, the first bank node is configured to transmit the first fund transfer command to a first central bank system and the account platform, wherein the account platform transmits the first fund transfer command to a second bank node connected to a second central bank system, wherein the first fund transfer command triggers transfer of the transaction amount between an account linked to the first customer identifier managed by the first bank node and an account linked to the second customer identifier manages by the second bank node, wherein the first bank node transfers the transaction amount from the first central bank, wherein the second bank node transfer the transaction amount to the second central bank, wherein the account platform generates the block data structure indicating the first central bank and the second central bank.

In some embodiments, the first bank node and the second bank node are configured to implement a currency exchange component to exchange the transaction amount from a first currency amount to a second currency amount, wherein the account platform generates the block data structure indicating the first currency amount and the second currency amount.

In some embodiments, the first bank node is configured to trigger a transfer of the transaction amount between an account linked to the first customer identifier and an account linked to the second customer identifier for internal settlement, the account linked to the first customer identifier and the account linked to the second customer identifier managed by the first bank node.

In some embodiments, the account platform generates a deposit block data structure for a deposit of the transaction amount to the account linked to the second customer identifier and a withdrawal block data structure for a withdrawal of the transaction amount from the account linked to the first customer identifier, wherein the interface displays visual representations corresponding a dynamic first customer record and a dynamic second customer record.

In some embodiments, wherein at least one bank node of the plurality of bank nodes is connected to a settlement bank system for transmission of the fund transfer commands.

In some embodiments, wherein a first bank node of the plurality of bank nodes is configured to: generate a first fund transfer command indicating a first customer identifier, a virtual token identifier, and a transaction amount; and transmit a transaction notification to the account platform; wherein the account platform is configured to: generate a block data structure indicating the first customer identifier, the virtual token identifier, and the transaction amount; and update the distributed ledger with the block data structure.

In another aspect, embodiments described herein provide a non-transitory computer readable medium having computer-executable instructions for causing a processor to: receive a transaction notification from a bank node connected to a central bank system, the transaction notification indicating a customer identifier and transaction data; create a block data structure for the transaction notification, the block data structure indicating the customer identifier and the transaction data; update, with the block data structure, a distributed ledger managed by a plurality of ledger nodes, each ledger node comprising at least one computing device; generate a customer record by aggregating a set of blocks of the distributed ledger, each block of the set of blocks indicating the customer identifier; and transmit the customer record to an interface to trigger display of visual elements corresponding to the customer record on a display device.

In some embodiments, the computer-executable instructions are for causing the processor to transmit a fund transfer command to the central bank system, the fund transfer commands indicating the customer identifier and the transaction data.

In some embodiments, the computer-executable instructions are for causing the processor to: generate a first fund transfer command indicating a first customer identifier, a second customer identifier, and a transaction amount; and transmit a transaction notification to the account platform; generate a block data structure indicating the first customer identifier, the second customer identifier, and the transaction amount; and update the distributed ledger with the block data structure to provide notification to the other of the plurality of bank nodes.

In some embodiments, the computer-executable instructions are for causing the processor to transmit the first fund transfer command to the central bank system to trigger transfer of the transaction amount between an account linked to the first customer identifier and an account linked to the second customer identifier.

In some embodiments, the computer-executable instructions are for causing the processor to transmit the first fund transfer command to a first central bank system and the account platform, transmit the first fund transfer command to a second bank node connected to a second central bank system, wherein the first fund transfer command triggers transfer of the transaction amount between an account linked to the first customer identifier managed by the first bank node and an account linked to the second customer identifier manages by the second bank node, wherein the first bank node transfers the transaction amount from the first central bank, wherein the second bank node transfer the transaction amount to the second central bank, wherein the processor generates the block data structure indicating the first central bank and the second central bank.

In some embodiments, the first bank node and the second bank node are configured to implement a currency exchange component to exchange the transaction amount from a first currency amount to a second currency amount, wherein the processor generates the block data structure indicating the first currency amount and the second currency amount.

In some embodiments, the computer-executable instructions are for causing the processor to trigger a transfer of the transaction amount between an account linked to the first customer identifier and an account linked to the second customer identifier for internal settlement, the account linked to the first customer identifier and the account linked to the second customer identifier managed by the first bank node.

In some embodiments, the computer-executable instructions are for causing the processor to generate a deposit block data structure for a deposit of the transaction amount to the account linked to the second customer identifier and a withdrawal block data structure for a withdrawal of the transaction amount from the account linked to the first customer identifier, wherein the interface displays visual representations corresponding a dynamic first customer record and a dynamic second customer record.

In some embodiments, wherein at least one bank node of the plurality of bank nodes is connected to a settlement bank system for transmission of the fund transfer commands.

In some embodiments, the computer-executable instructions are for causing the processor to generate a first fund transfer command indicating a first customer identifier, a virtual token identifier, and a transaction amount; and transmit a transaction notification to the account platform; generate a block data structure indicating the first customer identifier, the virtual token identifier, and the transaction amount; and update the distributed ledger with the block data structure.

In some embodiments, there is provided a network of bank nodes to transfer funds to central bank systems, and an account platform to generate data elements of transactions and record the data elements of the transactions on a distributed ledger provided by computing devices, at least one transaction being linked to a customer identifier, the account platform being configured to generate and output dynamic customer records using the distributed ledger in response to receiving the customer identifier, wherein at least one data element is linked to a central bank identifier, wherein the account platform is configured to generate the dynamic customer records using the central bank identifier.

In some embodiments, there is provided a network with a plurality of bank nodes, each bank node connected to a corresponding central bank system to transmit fund transfer commands to trigger a transaction exchange, wherein a first bank node of the plurality of bank nodes is configured to: generate a first fund transfer command indicating a first customer identifier, a virtual token identifier, and a transaction amount; transmit a first transaction notification to an account platform, the transaction notification corresponding to the first fund transfer command; the account platform connecting to the plurality of bank nodes and having non-transitory computer-readable storage medium with computer-executable instructions for causing a processor to: receive the first transaction notification; generate a block data structure indicating the first customer identifier, the virtual token identifier, and the transaction amount; and update a distributed ledger with the block data structure using at least one ledger node of a plurality of ledger nodes managing the distributed ledger, each ledger node comprising at least one computing device; generate a dynamic customer record by aggregating block data structures indicating the first customer identifier; and an interface for displaying visual representations corresponding to the dynamic customer record.

In some embodiments, a first bank node of the plurality of bank nodes is configured to: generate a second fund transfer command indicating the first customer identifier, a second customer identifier, the virtual token identifier, and another transaction amount; and transmit a second transaction notification to the account platform; wherein the account platform is configured to: generate another block data structure indicating the first customer identifier, the second customer identifier, the virtual token identifier, and the other transaction amount; update the distributed ledger with the other block data structure; and re-generate the dynamic customer record to update the interface.

In some embodiments, the first bank node is configured to transmit the first fund transfer command to the corresponding central bank system to trigger transfer of the transaction amount between an account linked to the first customer identifier.

In some embodiments, the first bank node is configured to transmit the first fund transfer command to a first central bank system and the account platform, wherein the account platform transmits the first fund transfer command to a second bank node connected to a second central bank system, wherein the first fund transfer command triggers transfer of the transaction amount for an account linked to the first customer identifier managed by the second bank node, wherein the second bank node transfer the transaction amount to the second central bank, wherein the account platform generates the block data structure indicating the second bank node and the second central bank.

In some embodiments, the first bank node and the second bank node are configured to implement a currency exchange component to exchange the transaction amount from a first currency amount to a second currency amount, wherein the account platform generates the block data structure indicating the first currency amount and the second currency amount.

In some embodiments, the first bank node is configured to trigger a transfer of the transaction amount between an account linked to the first customer identifier and an account linked to the second customer identifier for internal settlement, the account linked to the first customer identifier and the account linked to the second customer identifier managed by the first bank node.

In some embodiments, the account platform generates a deposit block data structure for a deposit of the transaction amount to the account linked to the second customer identifier and a withdrawal block data structure for a withdrawal of the transaction amount from the account linked to the first customer identifier, wherein the interface displays visual representations corresponding to a dynamic first customer record and a dynamic second customer record.

In some embodiments, at least one bank node of the plurality of bank nodes is connected to a settlement bank system for transmission of the fund transfer commands.

In some embodiments, there is provided a non-transitory computer readable medium having computer-executable instructions for causing a processor to: receive a transaction notification from a bank node connected to a central bank system, the transaction notification indicating a customer identifier, a virtual token identifier, and transaction data; create a block data structure for the transaction notification, the block data structure indicating the customer identifier, the virtual token identifier, and the transaction data; update, with the block data structure, a distributed ledger managed by a plurality of ledger nodes, each ledger node comprising at least one computing device; generate a customer record by aggregating a set of blocks of the distributed ledger, each block of the set of blocks indicating the customer identifier; and transmit the customer record to an interface to trigger display of visual elements corresponding to the customer record on a display device.

In some embodiments, the non-transitory computer readable medium has computer-executable instructions for causing the processor to transmit a fund transfer command to the central bank system, the fund transfer commands indicating the customer identifier, the virtual token identifier, and the transaction data.

In some embodiments, the non-transitory computer readable medium has computer-executable instructions for causing the processor to: generate a first fund transfer command indicating a first customer identifier, the virtual token identifier, a second customer identifier, and a transaction amount; and transmit a transaction notification to the account platform; generate a block data structure indicating the first customer identifier, the virtual token identifier, the second customer identifier, and the transaction amount; and update the distributed ledger with the block data structure to update the dynamic customer record at the interface.

In some embodiments, the non-transitory computer readable medium has computer-executable instructions for causing the processor to transmit the first fund transfer command to the central bank system to trigger transfer of the transaction amount from an account linked to the first customer identifier or an account linked to the second customer identifier.

In some embodiments, the non-transitory computer readable medium has computer-executable instructions for causing the processor to transmit the first fund transfer command to a first central bank system and the account platform, transmit the first fund transfer command to a second bank node connected to a second central bank system, wherein the first fund transfer command triggers transfer of the transaction amount from an account linked to the first customer identifier managed by the first bank node or an account linked to the second customer identifier manages by the second bank node, wherein the first bank node transfers the transaction amount from the first central bank, wherein the second bank node transfers the transaction amount to the second central bank, wherein the processor generates the block data structure indicating the first central bank and the second central bank.

In some embodiments, the first bank node and the second bank node are configured to implement a currency exchange component to exchange the transaction amount from a first currency amount to a second currency amount, wherein the processor generates the block data structure indicating the first currency amount and the second currency amount.

In some embodiments, the non-transitory computer readable medium has computer-executable instructions for causing the processor to trigger a transfer of the transaction amount between an account linked to the first customer identifier and an account linked to the second customer identifier for internal settlement, the account linked to the first customer identifier and the account linked to the second customer identifier managed by the first bank node.

In some embodiments, the non-transitory computer readable medium has computer-executable instructions for causing the processor to generate a deposit block data structure for a deposit of the transaction amount to the account linked to the second customer identifier and a withdrawal block data structure for a withdrawal of the transaction amount from the account linked to the first customer identifier, wherein the interface displays visual representations corresponding a dynamic first customer record and a dynamic second customer record.

In some embodiments, the at least one bank node of the plurality of bank nodes is connected to a settlement bank system for transmission of the fund transfer commands.

Many further features and combinations thereof concerning embodiments described herein will appear to those skilled in the art following a reading of the instant disclosure.

### DESCRIPTION OF THE FIGURES

Embodiments will now be described, by way of example only, with reference to the attached figures, wherein in the figures:

FIG. 1 is schematic diagram of a network of bank nodes according to some embodiments;

FIG. 2 is schematic diagram of a system with an account platform according to some embodiments;

FIG. 3 is schematic diagram of an account platform according to some embodiments;

FIG. 4 is a workflow diagram of a method for an account platform according to some embodiments;

FIG. 5 is a diagram of an interface of account platform according to some embodiments;

FIG. 6 is a schematic diagram of a computing device connecting with account platform according to some embodiments;

FIG. 7 is a diagram of a central-bank connecting to a bank node according to some embodiments;

FIG. 8 is a diagram of a central-bank connecting to a bank node to transfer funds between customers according to some embodiments;

FIG. 9 is a diagram of a central-bank connecting to a bank node to transfer funds between customers according to some embodiments;

FIG. 10 is a diagram of a central-bank connecting to a bank node and a settlement bank according to some embodiments;

FIG. 11 is a diagram of a central-bank connecting to a bank node and a settlement bank to transfer funds between customers according to some embodiments;

FIG. 12 is a diagram of a central-bank connecting to a bank node and a settlement bank to transfer funds between customers according to some embodiments;

FIG. 13 is a diagram of central banks connecting to bank nodes according to some embodiments;

FIG. 14 is a diagram of central banks connecting to bank nodes to transfer funds between customers according to some embodiments;

FIG. 15 is a diagram of central banks connecting to bank nodes to transfer funds between customers according to some embodiments;

FIG. 16 is a diagram of central banks connecting to bank nodes and settlement banks according to some embodiments;

FIG. 17 is a diagram of central banks connecting to bank nodes and settlement banks to transfer funds between customers according to some embodiments;

FIG. 18 is a diagram of central banks connecting to bank nodes and settlement banks to transfer funds between customers according to some embodiments;

FIG. 19 is a diagram of central banks connecting to bank nodes and settlement banks to transfer funds between customers according to some embodiments;

FIG. 20 is a diagram of central banks connecting to bank nodes and settlement banks and market makers to transfer funds between customers according to some embodiments;

FIG. 21 is a diagram of central banks connecting to bank nodes and settlement banks to transfer funds between customers according to some embodiments;

FIG. 22 is a diagram of central banks connecting to bank nodes and settlement banks to transfer funds between customers according to some embodiments;

FIG. 23 is a diagram of central banks connecting to bank nodes and settlement banks to transfer funds between customers according to some embodiments; and

FIG. 24 is a diagram of a bank node or narrow bank with a cryptocurrency application.

### DETAILED DESCRIPTION

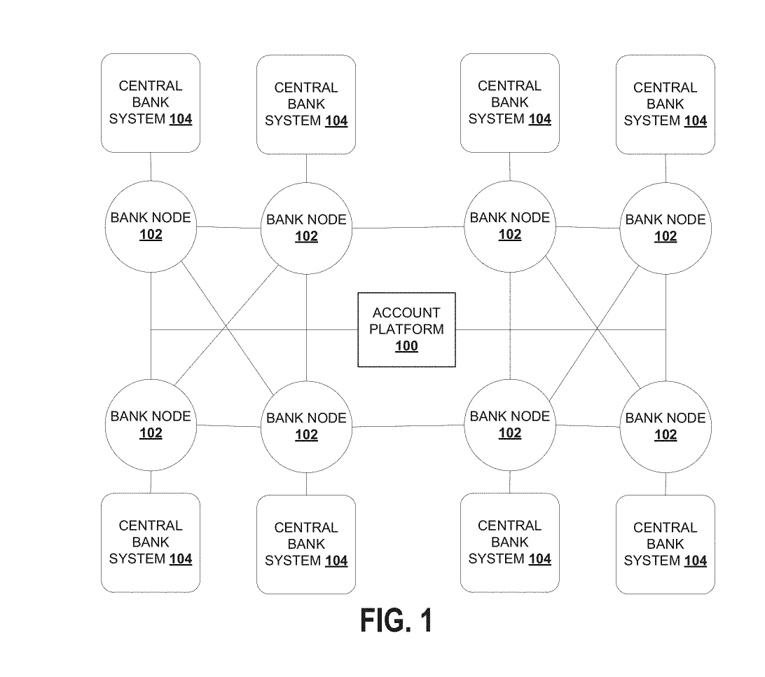

FIG. 1 shows an example of an account platform 100 with a distributed network of bank nodes 102. Each bank node 102 has a network interface to communicate with other bank nodes 102 and central bank systems 104. The bank nodes 102 can connect through a distributed network. The bank nodes 102 connect to the account platform 100 through various network connection links. A bank node 102 connects to a central bank system 104 through various network connection links.

The account platform 100 centrally manages bank accounts for different customers. Each bank account is linked to one or more bank nodes 102. Each bank node 102 includes a processor to execute instructions stored in a persistent data store in order to implement or perform a number of different functions for secure transactions (e.g. deposits and withdraws) with one or more central bank systems 104. Example customers include institutions, sovereigns, fund managers, and high net worth individuals. The account platform 100 receives deposits from customers for secure storage with central-bank systems 104 that manage central bank accounts in various currencies. The account platform 100 receives account messages relating to the deposits from customers for record keeping based on distributed ledger technology.

The account platform 100 provides a transactional framework with increased data security based on distributed ledger technology. The account platform 100 manages customer transactions to deposit and withdraw funds from central-bank systems 104. The account platform 100 provides a web interface and a mobile application interface to receive customer requests to trigger various transactions and transmit information in response to the customer requests. The account platform 100 can use biometric security measures to enhance security. The account platform 100 uses encryption algorithms to protect data and messages exchanged between the account platform 100, bank nodes 102, and central-bank systems 104.

The account platform 100 implements isolation of checking and saving accounts at hardware, network and software layers. This can enhance the security of saving accounts holding the bulk of the total assets to be unconstrained by the requirements of less secure checking accounts. Data can be secured with distributed ledger technology coupled to advance cryptographic algorithms, secure multiparty computation and secret sharing. The saving account balances can be held in a ledger managed by a dedicated server of the account platform 100. In some embodiments, the ledger can be hosted on the dedicated server that can be encrypted with an NIST-approved AES encryption algorithm. The account platform 100 can generate a centralized view of the distributed ledger by retrieving data from a block chain managing the distributed ledger. For example, blocks or components of the block chain can be distributed across a multiple devices, servers or systems and the account platform 100 is configured to generate of real-time visualization of the data or a subset of the data recorded in the blocks.

A bank node 102 enables a customer linked to a bank account to deposit money into a central bank by way of its corresponding central bank system 104. For example, account platform 100 may trigger a customer deposit into a particular bank node 102. Upon receipt of the customer deposit, the bank node 102 immediately makes a corresponding customer deposit into a central bank system 104. As another example, account platform 100 may trigger a customer withdraw into a particular bank node 102. Upon receipt of the customer withdraw request, the bank node 102 immediately makes a corresponding customer withdraw from a central bank system 104. The bank node 102 transfers the customer withdraw to the account platform 100 or another system associated with the customer. The customer deposit or withdraw can be way of electronic transfer, for example.

In some embodiments, there may be a bank node 102 for each central bank system 104. That is each bank node 102 may be tied to a specific jurisdiction (OECD country). A bank node 102 can perform an exchange function to transfer customer withdraws and deposits between different currencies. The bank nodes 102 can handle different currencies and also non-traditional or digital currencies.

Account platform 100 generates and updates a distributed, decentralized ledger of customer accounts, bank node accounts, and central bank system accounts. The ledger includes records for the different customer deposits and customer withdraws. The distributed ledger may be implemented using block chain, as will be described herein. For example, when a new customer deposit is received at a bank node 102 or account platform 100, then the account platform 100 creates a new block in a block chain for the ledger of customer accounts, the new block recording information relating to the new customer deposit including account name, account number, deposit amount, currency, banknote identifier, central bank identifier, customer identifier, and so on. Account platform 100 uses the ledger to manage the bank nodes 102. For example, account platform 100 creates a block in a block chain for each bank node 102. As another example, account platform 100 assigns one or more identifiers to each bank node 102. The account platform 100 uses the distributed, decentralized ledger to generate different data structures, reports, visual representations of data for the bank nodes 102, the customer accounts, central bank systems 104, and so on.

A block chain is a distributed database or ledger made up of data structures or blocks that represent customer transactions or data records. A block can be linked to one or more customer identifiers that identify a customer of account platform 100. A customer account record includes the data from one or more blocks linked to the customer identifier. The account platform 100 is configured to generate a dynamic customer account record by identifying the one or more blocks linked to the customer identifier. The block chain can be stored by one or more devices. The blocks store data elements for the customer account records. The account platform 100 is configured to aggregate data elements from multiple blocks to dynamically generate the customer account record. For example, a customer account record can indicate real-time data for a customer such as a number of transactions, the amount of transactions, bank nodes 102 linked to the transactions, central-bank systems 104 linked to the transactions, different amounts of currency, a total amount of funds, and so on.

A block can be linked to one or more bank identifiers that identify a bank node 102. A bank node account record includes the data from the one or more blocks linked to the bank identifier. The account platform 100 is configured to generate a dynamic bank node account record by identifying the one or more blocks linked to the bank identifier. The blocks store data elements for the bank account record. The account platform 100 is configured to aggregate data elements from multiple blocks to dynamically generate the bank node account record. For example, a bank node account record can indicate data for a bank node 102 such as a number of transactions, the amount of transactions, customers linked to the transactions, bank nodes linked to the transactions, a total amount of funds, and so on.

A block can be linked to one or more central-bank identifiers that identify a central-bank system 104. A central-bank system account record includes the data from the one or more blocks linked to the central-bank identifier. The account platform 100 is configured to generate a dynamic central bank account record by identifying the one or more blocks linked to the bank identifier. The blocks store data elements for the central-bank account record. The account platform 100 is configured to aggregate data elements from multiple blocks to dynamically generate the central-bank account record. For example a central-bank account record can indicate data for a central-bank system 104 such as a number of transactions, a type of currency, exchange rate, the amount of transactions, customers linked to the transactions, bank nodes 102 linked to the transactions, a total amount of funds, and so on.

The distributed ledger can be stored across multiple entities, devices, servers, or systems. Each device is configured to store a version of or a portion of the distributed ledger a block chain. The block chain may be updated from time to time with modifications to the ledger and/or ledger entries, such as insertion of a new block. The distributed ledger can be configured with issue resolution logic to automatically resolve issues (insertions at the same time, corrupted entries, hash collisions, and so on). The issue resolution logic can also be distributed across the entities, devices, servers or systems so that the individual devices can handle and automatically resolve issues. In some embodiments, the block chain is stored and maintained on a set of trusted devices such as authorized computing devices. In some embodiments, the block chain may utilize encryption technology to validate biometric signatures to ensure the integrity of the blocks. There may be different levels of trusted devices with differing characteristics and business logic. The data stored by the block chain may be used to dynamically generate records in real-time. In some embodiments, the block chain is only accessible to select, authorized devices having the appropriate permissions, digital tokens, and other credentials.

In some embodiments, the block chain is only accessible by the account platform 100. The account platform 100 can create new blocks and retrieve data from the blocks of the block chain. The data stored on blocks may be encrypted, redacted, compressed, and so on. Different devices may have different versions of the block chain or blocks of the block. The block chain may be maintained by the propagation of blocks across the different devices. In some embodiments, the blocks are adapted to have various links to other blocks so that the integrity of the blocks can be validated. For example, the links may include hashes computed based on prior entries in the block chain. This can be used to determine whether a block is a fraudulent entry by reviewing the correctness of the hash based on a hash of data stored in prior blocks. The set of devices maintaining the block chain may be viewed as a distributed network system. This provides decentralized control and storage of the block chain or ledger at the one or more devices. The devices can be considered nodes of the decentralized network system. The number of nodes may be fixed or vary with time. In some embodiments, the devices can store multiple copies of blocks of the block chain or multiple entries of the ledger to provide cross validation in the event of conflicts.

Each block in the block chain includes one or more identifiers of a set of identifiers for a customer, bank node 102, or central-bank system 104 along with transaction data or other data related to the account platform 100. If there is more than one block in the block chain then each block beyond the first block includes a hash of a previous block in the block chain. The block can also include his timestamp indicating when the block was created. An identifier is a value or metric that can uniquely identify a customer, a bank node 102, or a central-bank system 104.

The account platform 100 uses a distributed ledger system for data immutability. The account platform 100 implements a universal tamperproof lecture where records are irreversible. Immutability eliminates the need for reconciliation and provides historical single version of the record. The account platform uses a distributed ledger system for data automation. The account platform 100 does not need human interaction, conflicting or double transactions are not permanently written in the ledger. The account platform provides trust and verification. The account platform 100 brings data transparency. A consensus mechanism governs the update of the ledger in a transparent fashion the data records from different nodes 102 and central-bank system 104 are available for inspection by the relevant regulators in real-time. The account platform 100 uses a secure multiparty computation paradigm to allow customers to verify that the bank node 102 will implement and fulfil the deposit and withdraw transactions upon request.

A customer transaction may be a corporate deposit, including non-operational deposits. Other examples include deposits from large financial institutions, deposits from corporate entities, and deposits from the retail sector. Other examples include treasury services, payroll remittance, payroll administration and control over the distribution of funds, and confirmation of payment orders. Additional examples include payments in local and foreign currencies, including transmission reconciliation and confirmation of foreign exchange. Other examples include custodial services, escrow, funds transfer, stock transfer and agency services. The account platform 100 can also implement transactions for payment of fees, taxes and other expenses an issue digital currency. Accordingly, customer account records can relate to non-operational deposits and other types of transactions. The account platform uses the distributed ledger system to provide lean, efficient and scalable infrastructure.

The account platform 100 can provide for increased security for deposit transactions as a bank node 102 can be tied to a central-bank system 104 in a non-co-mingled way. The bank nodes 102 can provide a network of banks in different jurisdictions. The bank nodes 10 enable customers to deposit money into a central-bank system 104. A customer can deposit funds into a safe bank node 102 which then immediately transfers the deposit to a central-bank system 104. Each bank node 102 can deposit or withdraw funds into a central-bank 104 of its respective country. Account platform 100 also provides an exchange function to transfer funds between currencies. The account platform 100 provides a distributed system over a network of nodes 102 with security techniques to manage operational efficiency.

The bank nodes 102 have a network interface to exchange data and commands with other bank nodes 102. The bank nodes 102 also use the network interface to exchange data and commands with the central-bank system 104 and account platform 100.

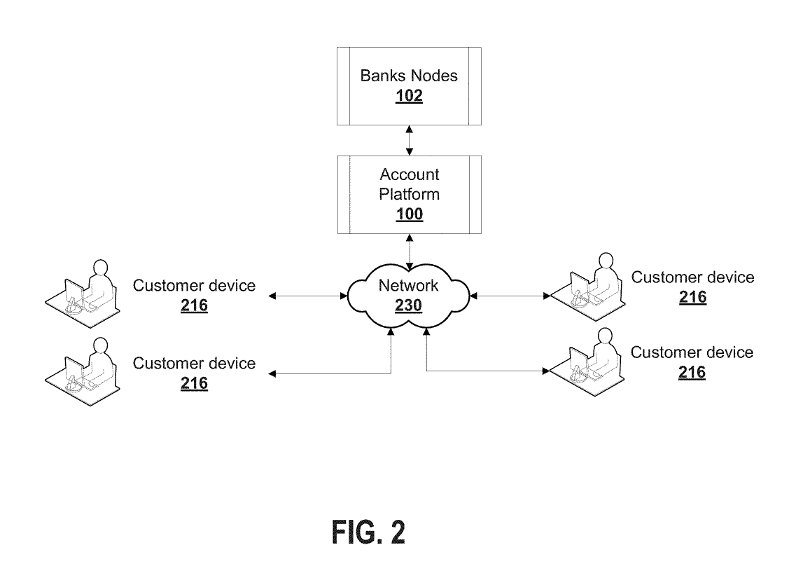

FIG. 2 is schematic diagram of system with an account platform 100 according to some embodiments. Account platform 100 connects to customer devices 216 via network 230. Account platform 100 receives transaction requests from customer devices 216. In response, account platform 100 relays the transaction requests to one or more bank nodes 102. The bank nodes 102 then process the transaction with one or more central bank systems 104. For example, the account platform 100 can receive a deposit request from a customer device 216. The deposit request can indicate a deposit amount, customer identifier, account identifier, bank identifier, and so on. The account platform 100 can process the deposit request by retrieving data for the account, customer, and bank from the block chain or distributed ledger. The account platform 100 can trigger creation of a block in the block chain to record data for the deposit transaction. The account platform 100 creates a data record for the deposit transaction that includes a timestamp, banknote identifier, account identifier, customer identifier, deposit amount, and so on. The block or data record can also include other attributes regarding the deposit transaction. The account platform 100 relays the deposit request to a corresponding bank node 102. For example, the deposit request can be in the Canadian dollar currency and a bank node 102 that receives the request may connect directly to the Canadian central-bank to deposit the Canadian funds. The bank node 102 has a central-bank account to deposit and withdraw funds.

Accordingly, the account platform 100 connects to a network of bank nodes with the purpose to safely manage funds for customers including institutions, sovereigns, fund managers and high net worth individuals, for example. The account platform 100 provides lower risk and a higher level of efficiency and security than existing bank systems. The account platform 100 can respond and process different transaction requests including cash management, domestic payments, in fiat, digital currencies, and foreign exchange. Customer assets are not co-mingled with other bank assets and instead are deposited directly in central-bank systems 104 by bank nodes 102 and linked directly to the customer identifier. The block chain or distributed ledger also records a link between the transaction and the customer identifier. This provides a record to directly identify the customer assets so that they do not co-mingle with other assets managed by the bank nodes 102.

The account platform 100 uses verifiable record-keeping as the distributed ledger reflects flows of money and credit between the bank nodes 102 and the central bank systems 104. Conventional bank systems face significant risks including but not limited to credit, market, liquidity, operational, legal, and reputational risk. Traditionally, determinants of banks quality and reliability are the amount of capital and the level of liquidity kept in the form of central-bank money and other high-quality liquid instruments. Bank systems need to maintain the right levels of both capital and liquidity. If the bank has too little it becomes fragile if the bank has too much it becomes unprofitable and hence unable to pay customers. In both cases, banks become vulnerable to default. It can be risky for institutions to store and manage large sums of cash above and beyond insured limits since depositors are treated as junior creditors in the bank default scenario. This poses a risk for depositors as in the case of default they will lose the deposits above the regulatory guaranteed minimum period.

Banks have market and credit risks. Banks can construct the liability side of a balance sheet by committing their own capital attracting depositors and selling bonds. They then convert some of these liabilities into loans and keep the rest in central-bank cash. Banks can build a risky asset side to charge higher interest and finance themselves through short dated borrowing and deposits to pay low interest on such borrowings. Therefore, in search of higher net interest margins, banks can become maturity transformation systems for paying dividends. This process creates inherent risk. Banks have liquidity risks. Despite regulatory reforms, some banks remain risky especially on the liquidity side. Under stress a bank might not be able to fill all of their immediate payment obligations, while being technically solvent. Potential liquidity complications can jeopardize not only individual banks but the entire banking system. Balance sheets have complexity risks. Balance sheets can be opaque and risks are not well understood by regulators, depositors, investors, or even internal management. This complexity can reach high levels and may be become too big to manage. Organizations spent hundreds of millions and in some cases over billions of dollars per annum developing and maintaining complex models, systems, and other infrastructure to demonstrate compliance with these capital and liquidity requirements.

Account platform 100 manages large cash deposits and related transactions for depositors. The account platform 100 maintains a distributed ledger or block chain with detailed data records to avoid co-mingling cash deposits of customers with risky assets. The account platform 100 connects to the network of bank nodes 102 to deposit and withdraw funds with central-bank systems 104. The account platform 100 enables corporations, financial institutions, and individuals to instantaneously deposit currencies with the corresponding central-bank systems 104. Upon receipt of the transaction request, the bank node 102 is configured to automatically redeposit any funds it receives with the central-bank system 104 corresponding to the currency received or requested. Cash management and exchange facilities are also functions of the account platform 100 to minimize risk and reducing time that funds are in-transit between central bank systems 104, client accounts and bank nodes 102. Account platform 100 uses security mechanism and encryption technology to maximize the security of its systems and networks. The account platform 100 connects to the network of bank nodes 102 that can be registered with different nations to ensure regulatory banking compliance. Each of the bank nodes 102 manage risk by immediately and automatically placing deposits solely into its central bank cash account with the central-bank system 104 of the corresponding country or currency. This can reduce market, credit, and liquidity risks.

The distributed ledger and block chain provide an efficient and transparent balance sheet tracking all transactions by customer identifier, bank identifier, and central-bank identifier. The account platform 100 can generate data models for particular customers dynamically and in real time by retrieving data from the distributed ledger of the block chain. The data can include blocks linked to the customer identifier, bank identifier, and in central-bank identifier. For example, a customer transaction request can be a withdraw request in US dollar currency. Account platform 100 can respond to the transaction request by determining in real time using the distributed ledger the total amount of available funds associated with the customer identifier. If the total amount of available funds is larger than the amount of the withdrawal request, the account platform 100 confirms that the withdrawal request can be processed. The account platform 100 is operable to determine the total amount of available funds currently available in US dollar currency. If there are insufficient funds available in US dollar currency, the account platform 100 is configured to implement an exchange function to transform funds in one currency into US dollar currency to execute the withdrawal request. The account platform 100 is operable to identify the central-bank systems 100 that are storing funds for the withdrawal request along with the corresponding bank nodes 102. The account platform 100 is operable to transmit a withdrawal request command to the bank node 102 that corresponds to the central-bank system 10 for storing the funds for the withdrawal request. In response, the bank node 102 transmits a withdrawal request command to the central-bank system 104. The central-bank system 104 transmits the funds to the bank node 102. The bank node 102 than transmits the funds to a customer account or address specified in the withdrawal request. The account platform 100 creates a block to store a data record for the withdrawal transaction. The data record includes a customer identifier, transaction details, timestamp, banknote identifier, and central-bank system identifier, and so on. The block may contain a hash to other blocks linked to the customer identifier, or a block storing a customer profile for example.

Multicurrency accounts are important for customers and the account platform 100 is operable to provide multicurrency services while retaining a minimal risk profile and recording balance sheets on the distributed ledger. Market risk from exchange transactions can be mitigated by establishing a bank node 102 connecting to a central-bank system 104 for major currencies or customers want to retain deposits. The account platform 100 is operable to internalize exchange transactions between the bank node 102 central-bank cash accounts managed by central-bank systems 104. This can reduce risk inherent in exchange transactions and can lower transaction costs. When internalization is not possible, the account platform 100 can manage exchange risk using rapid, secure transactions with correspondent bank systems using a continuously linked settlement system to mitigate potential risk. The account platform 100 can provide other services such as for example, treasury, custodial, digital identity storage and so on. The platform 100 can include software instructions to control capital, liquidity, and leverage levers.

The account platform 100 can implement an operational bank system with activities including processing deposit transactions for customers storing funds in central-bank cash accounts in various currencies managed by different central-bank systems 104. In addition, the account platform 100 provides transactional services to customers in various currencies in a manner to mitigate market, credit or liquidity risks. The account platform 100 and its associated central-bank cash accounts can receive interest from central bank systems 104 and transactional banking fees. The account platform 100 uses the bank nodes 102 to directly access central-bank systems 104.

The account platform 100 provides different external interfaces including a web and mobile application interface. The account platform 100 can use biometric mechanisms to increase security. The account platform 100 can build military grade encryption algorithms into its infrastructure.

The account platform 100 uses different security measures including a complete isolation of checking and savings accounts at hardware, network and software layers. This isolation will allow the security of savings accounts holding the bulk of the total assets to be unconstrained by transaction requirements of relatively less secure checking accounts. Data can be secured using the distributed ledger technology coupled to advance cryptographic algorithms, secure multiparty computation, and secret sharing.

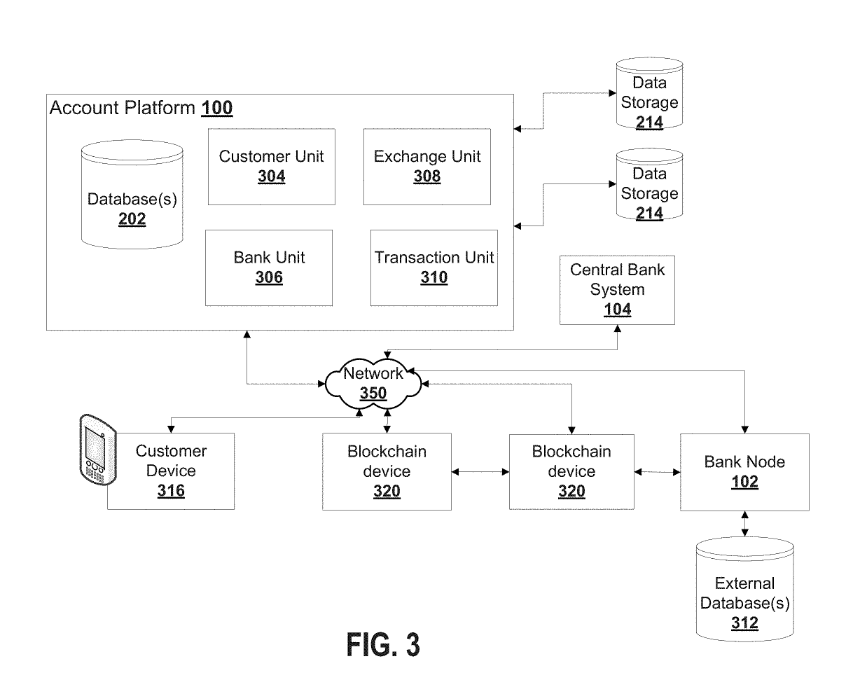

FIG. 3 is schematic diagram of an account platform 100 according to some embodiments. Account platform 100 includes databases 202 for managing local account related data. Account platform 100 also connects to one or more external data storages 214. Account platform 100 connects to one or more block chain devices 310 to update the distributed ledger and retrieve data from the distributed ledger managed by the block chain. The account platform also connects to one or more customer devices 216, bank nodes 102, and central-bank systems 104.

The account platform 100 includes a customer unit 304 to connect to one or more customer devices 216. The customer devices 216 can transmit transaction requests to the customer units 304. In response, the customer unit 304 is configured to dynamically and in real time generate a data set for a corresponding customer identifier linked to the customer device to evaluate whether the transaction can be processed. The customer device 216 can transmit customer configurations for a customer profile. The configurations can include a preferred currency, authorize customer accounts, threshold values and so on. The customer unit 304 is operable to interact with block chain devices 320 to retrieve data from the distributed ledger related to the customer device 216 and linked to the corresponding customer identifier. The customer unit 304 is operable to interact with transaction unit 310 to trigger creation of blocks of data records for customer devices 216. The blocks include data regarding the transaction as well as the customer identifier, banknote identifier, central bank identifier, and so on.

The account platform 100 includes a bank unit 306. The bank unit 306 can transmit transaction requests to bank nodes 102. The transaction requests can include a customer account for funds. The transaction request can be a deposit request which can include a customer account for the source of funds to be deposited in a central-bank system 104 by way of bank node 102. The bank unit 306 is configured to dynamically and in real time generate a data set for a corresponding bank node identifier to evaluate total funds being held in one or more central-bank cash accounts linked to a particular bank node 102. For example, a particular bank node 102 can have a central-bank cash account that stores funds on behalf of multiple customers. The data set can identify a total amount of funds being held in the central-bank cash account as well as a breakdown of funds allocated to different customers. This enables account platform 100 to have a data view of funds and central-bank cash accounts that does not commingle funds linked to different customers. The bank unit 306 can confirm that a transaction request has been processed by a bank node 102 and a central-bank system 104. The bank unit 306 can interact with transaction unit 310 to update or create a block on the block chain for the distributed ledger to record the transaction confirmation. The bank unit 306 is operable to interact with block chain devices 320 to retrieve data from the distributed ledger related to one or more bank nodes 102 and linked to the corresponding bank node identifier. The bank unit 306 is operable to interact with block chain devices 320 to store blocks of data records for bank nodes 102. The blocks include data regarding the transaction as well as the customer identifier, banknote identifier, central bank identifier, and so on.

The account platform 100 includes a transaction unit 310. The transaction unit 310 is operable to interact with block chain devices 320 to retrieve data from the distributed ledger related to one or more transactions and linked to a corresponding transaction identifier. The transaction unit 310 is operable to interact with block chain devices 320 to store blocks of data records for transactions processed by the account platform 100. The blocks include data regarding the transaction as well as the customer identifier, bank node identifier, central bank identifier, and so on. The transaction unit 310 is operable to interact with bank unit 306, customer unit 304 and exchange unit 3082 record data related to different transactions.

The account platform 100 includes an exchange unit 308. The exchange unit 308 is operable to interact with block chain devices 310 to retrieve data from the distributed ledger related to one or more currencies and a total amount of funds in different currencies for different customer identifiers. The exchange unit 308 is operable to receive exchange requests from customer device 216 or bank nodes 102. The exchange request can specify a desired currency. The exchange request can specify one or more source currencies for funds to be converted into the desired currency. The exchange request can include a customer identifier, a bank node identifier, central bank identifier, and so on. The exchange unit 308 is operable to interact with the transaction unit 310 to record a block of a data record for the exchange transaction on the distributed ledger of the block chain.

Account platform 100 can have an external data storage device 214 for saving account data and a separate external data storage device 214 for checking account data. The account platform 100 can segregate saving account data and checking account data to enhance security. The saving account balances can also be held in a central ledger hosted on a dedicated server or data storage device 214. The database 214 can be encrypted with an NIST approved AES encryption algorithm. The savings data storage server 214 can be hosted on dedicated servers located in secure data centres. There can be mirrored copies of the database located in different physical locations for backup and disaster recovery. The account platform 100 can use private networks 350 to connect to different components. For example the account platform 100 hardware and external data storage devices 214 can be interconnected by a dedicated proprietary network 350. The network 350 might not interconnect to the public Internet in some example embodiments. Communication among bank nodes 102 and account platform 100 can be secured and verified using the distributed ledger technology. Data for checking accounts can be held on a separate data storage device to one for implemented by servers protected using different security controls. Checking accounts by nature often require connection to external systems which may make them potentially more vulnerable to attacks. In the unlikely event of a breach the amount of damage can be contained if it is assumed that only a small fraction of funds will be held in checking accounts as compared to savings accounts. In addition, account platform 100 can employ client by client segregation in some embodiments. For example account platform 100 can use a separate block chain device 320 to store and manage data for a particular customer. As another example account platform 100 can use a separate data storage device 214 to store a manage data for a particular customer. In the unlikely event of one client's checking account breach it may not impact other clients.

The block chain devices 320 implement distributed ledger technology. The distributed ledger technology can provide data immutability. The blocks of the block chain implement a universal tamper proof ledger where records are irreversible. Immutability eliminates the need for reconciliation and provides a historical single version of a true data set. The distributed ledger technology can provide data automation. The account platform 100 does not need human interaction to verify conflicting transactions on the distributed ledger. The distributed ledger technology provides data transparency. A consensus mechanism governs the update of the ledger in a transparent fashion. Regulatory systems can connect to block chain devices 320 for relevant regulatory inspections in real time. Moreover, using a secure multiparty computation paradigm, the account platform allows customers to verify their particular fund holdings.

Account platform 100 can manage funds for different types of transactions. for example, account platform 100 can manage corporate nonoperational deposits. As another example, account platform 100 can manage deposits from large financial institutions, including clearing houses, large global banks, other sophisticated counterparties and global cash transactions. Account platform 100 can manage deposit corporate entities including treasury departments and foreign corporations, pension plans, sovereigns, and small and medium enterprise by offering services for secure deposits and global transactional banking. Account platform 100 can manage transactions for the retail sector. Account platform 100 can verify customers using a know your customer (KYC) system of reliable sources. Account platform 100 can manage transactions for targeted assets under management. Account platform 100 implements the know your customer system to comply with anti-money laundering requirements. Account platform 100 can use machine learning and achievement us and scalable know your clients anti-money laundering infrastructure to comply with legal requirements in several jurisdictions.

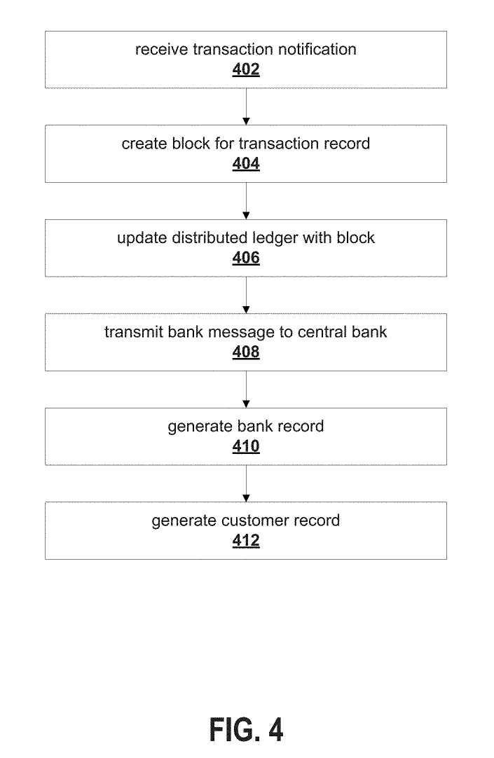

Referring now to FIG. 4, there is shown a flowchart diagram of a method for account platform 100. At 402, the account platform 100 receives deposit notification. The funds are transferred to bank node 102, such as by an electronic transfer from another bank. At 404, a deposit data record is created or updated as a new block to be added to the block chain. The account platform 100 interacts with the distributed ledger system to generate different data records dynamically and in real time. The account platform 100 immediately triggers an update to the distributed ledger at 406. The account platform 100 adds the new block to the distributed ledger system. The account platform 100 manages the network of bank nodes 102 to record transaction data. The bank node 102 transmits a message to inform the central-bank system 104 of the deposit transaction using a bank message at 408. The account platform 100 dynamically generates a bank record at 410. The account platform 100 dynamically generates a customer record at 412. The customer record up-to-date and real-time data from blocks linked to particular customer identifier. The blocks include data describing different transactions relating to customer accounts and customer transactions.

The account platform 100 implements and onboarding process to verify identities of customers. The transactions from bank nodes 102 to the central-bank systems 104 or linked to customer identifiers in the general ledger on the block chain. This enables the account platform 100 to generate dynamic date of use of customer funds with different central-bank systems 104 that are not co-mingled with other assets. A customer account may include data aggregated across the bank node network and distributed ledger. The account platform 100 implements a continuous real-time settlement. The account platform 100 identifies all data records linked to a customer identifier to generate an aggregated data view of the holdings of the particular customer across the network of bank nodes 102 and central-bank systems 104. Account platform 100 can implement a dark pool of off market transactions for exchange settlements. The account platform 100 can connect to other bank systems to implement different functionalities.

The account platform 100 is configured to connect to a risk calculation unit to generate a real-time and dynamic view of a customer or bank risk. An example risk calculation process and system by the Applicant is described in U.S. application Ser. No. 15/223,689 filed Jul. 29, 2016, the contents of which is hereby incorporated by reference.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

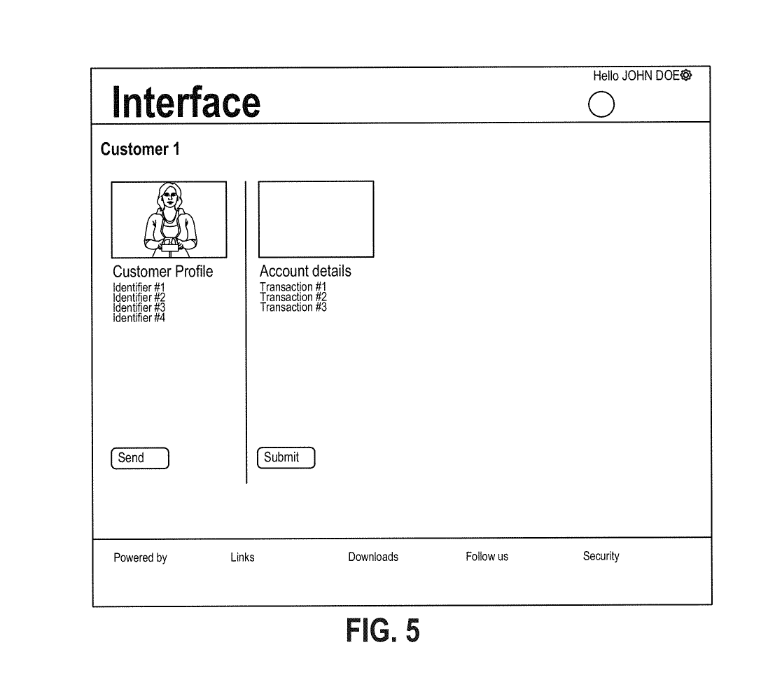

Referring now to FIG. 5 there is shown an example screenshot of an interface for accessing account platform 100 with user interface elements depicting a customer profile including customer identifiers and account details including multiple transactions.

The account platform 100 can be implemented using the server that connects to other components in various ways including directly coupled and indirectly coupled via the network. Network (or multiple networks) is capable of carrying data. Network can involve wired connections, wireless connections, or a combination thereof. Network may involve different network communication technologies, standards and protocols.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

Various example embodiments are described herein. Although each embodiment represents a single combination of inventive elements, all possible combinations of the disclosed elements include the inventive subject matter. Thus if one embodiment comprises elements A, B, and C, and a second embodiment comprises elements B and D, then the inventive subject matter is also considered to include other remaining combinations of A, B, C, or D, even if not explicitly disclosed.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information.

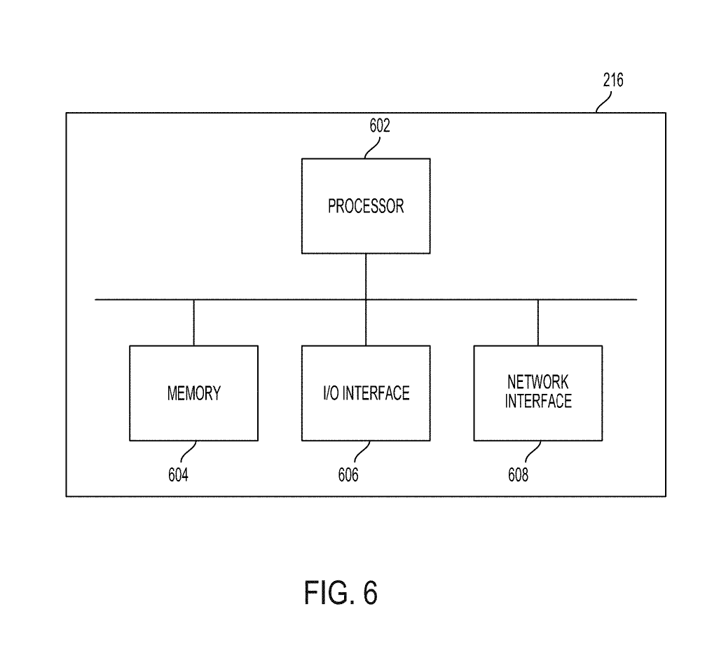

FIG. 6 is a schematic diagram of a computing device 216 connecting with account platform according to some embodiments. The client device 216 can include at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

Each processor may be, for example, any type of general-purpose microprocessor or microcontroller, a digital signal processing (DSP) processor, an integrated circuit, a field programmable gate array (FPGA), a reconfigurable processor, or any combination thereof.

Memory may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface enables computing device 216 to interconnect with one or more input devices, such as a keyboard, mouse, camera, touch screen and a microphone, or with one or more output devices such as a display screen and a speaker.

Each communication interface enables computing device 216 to communicate with other components, to exchange data with other components, to access and connect to network resources, to serve applications, and perform other computing applications by connecting to a network (or multiple networks) capable of carrying data.

Computing device 216 is operable to register and authenticate users (using a login, unique identifier, and password for example) prior to providing access to applications, a local network, network resources, other networks and network security devices. Computing devices 216 may serve one user or multiple users.

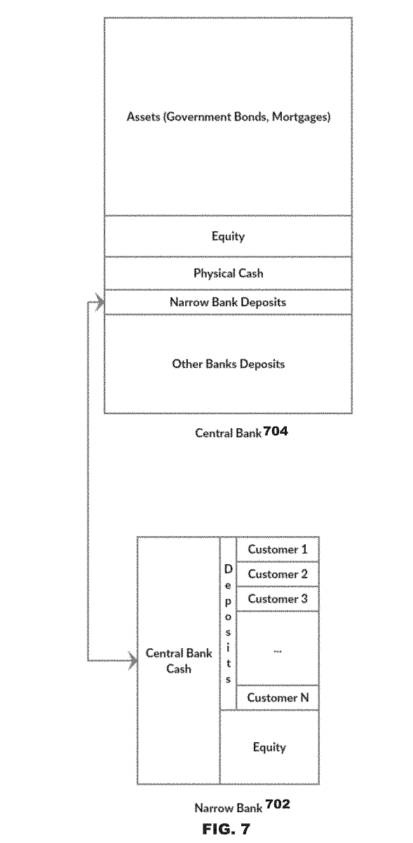

FIG. 7 is a diagram of a bank node 702 connecting to central-bank 704 according to some embodiments. In some embodiments, the bank node 702 can be referred to as a narrow bank in view of its narrow or focused transaction functionality for deposits, withdraws and exchanges. That is, a narrow bank can be a bank will all its assets kept with central banks. Bank node 702 can transmit messages to central-bank 704 to trigger transactions. Account platform 100 can receive the messages regarding the transactions to record the transactions as blocks on the distributed ledger using block chain device 320. In some embodiments, bank node 702 can transmit a message to account platform 100 which in turn relays it to central-bank 704. In some embodiments, bank node 702 can transmit a first message to central-bank and a copy of the first message to account platform 100. In some embodiments, bank node 702 can transmit a first message to central-bank 704 which in turn relays the message to account platform 100. Account platform 100 can record transactions between central bank 704 and bank node 702. In this example, central bank 704 and bank node 702 can be part of the same economy and exchange funds in the same currency for that same economy.

Central-bank 704 maintains data structures representing assets, equity, physical cash, narrow bank deposits, and other bank deposits. Account platform 100 is operable to maintain the data structures or a copy of the data structures as part of the distributed ledger using block chain device 320. Bank node 702 is operable to maintain data structures representing bank node identifiers, customer identifiers, deposit transactions, currency exchange transactions, withdraw transactions, central-bank cash and equity. Bank node 702 and central-bank 704 are operable to exchange funds to process transaction requests. The bank node 702 has a central-bank cash component that connects to a narrow bank deposit component of central bank 704 to exchange funds for transactions.

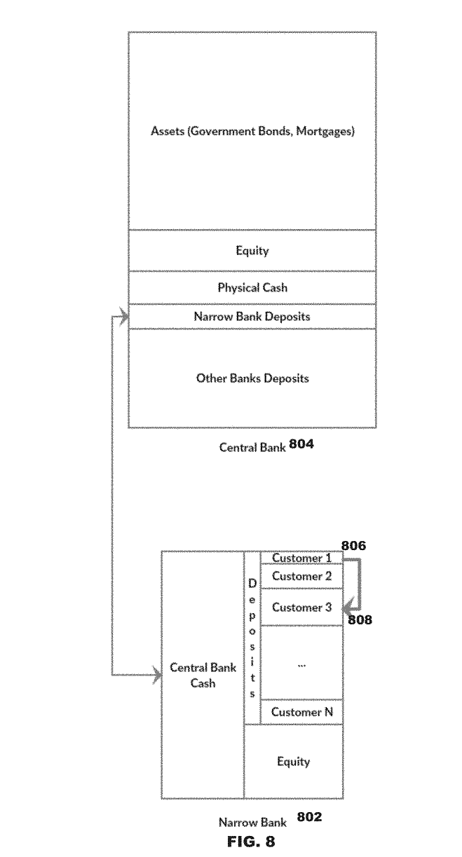

FIG. 8 is a diagram of a bank node 802 connecting to a central-bank 804 to transfer funds between customer accounts according to some embodiments. Bank node 802 triggers a transaction between customer 1 806 and customer 3 808. Bank node 802 transmits a message with the transaction request to central-bank 804 to withdraw funds from an account associated with customer 1 806 and to deposit the funds within an account associated with customer 3 808. Account platform 100 processes the message to record the transaction on the distributed ledger using the block chain device 320. The funds may be in the same currency so that no exchange transaction is required.

Bank node 802 transmits messages to other bank nodes in the network to inform the other bank nodes about the transaction. Bank node 802 generates a data element for the transaction and updates the distributed ledger with the data element. The other bank nodes can be notified of the transaction by way of the updated distributed ledger. The other bank nodes in the network can be informed about this transaction via the distributed ledger. This can enable transactions (such as FX transactions) to be settled internally within the network to the largest extend possible, in some embodiments. At the same time, if there are legal restrictions to the amount of information exchanged among different jurisdictions, customer accounts in the distributed ledger might be maintained under pseudonyms and limited to the balances they carry. The distributed ledger stores a block or data element for the withdrawal of funds and a block for the deposit of funds to maintain an up-to-date record of customer accounts. The bank node 802 can process the transaction internally given that the same central bank 804 stores the funds for the transaction for these customers 806, 808. It is not necessary for bank node 802 to engage the central bank 804 to process the transaction since transaction is internalized. At the level of central bank 804, customer funds can be commingled for bank node 802. The bank node 802 does not have to update or notify central bank 804 to complete this transaction as it can be settled internally.

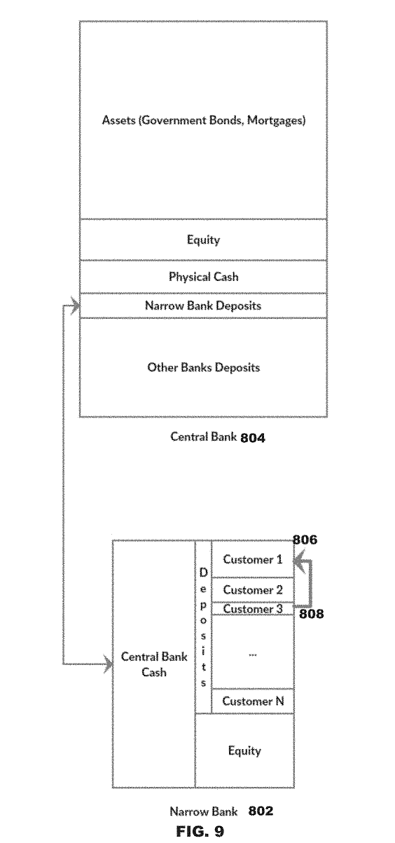

FIG. 9 is a diagram of a bank node 802 connecting to a central-bank 804 to transfer funds between customers according to some embodiments. Bank node 802 triggers a transaction between customer 1 806 and customer 3 808. Account platform 100 processes the message to record the transaction in the distributed ledger using the block chain device 320. The funds may be in the same currency so that no exchange transaction is required. The distributed ledger creates a block on the distributed ledger for the withdrawal of funds and a block on the distributed ledger for the deposit of funds to maintain an up-to-date record of customer accounts using the distributed ledger. The bank node 802 has a central-bank cash component that connects to a narrow bank deposit component of central bank 804 to exchange funds for transactions between customer 1 806 and customer 3 808, for example.

Bank node 802 transmits messages to other bank nodes in the network to inform the other bank nodes about the transaction. Bank node 802 generates a data element for the transaction and updates the distributed ledger with the data element. The other bank nodes can be notified of the transaction by way of the updated distributed ledger. The other bank nodes in the network can be informed about this transaction via the distributed ledger. This can enable transactions (such as FX transactions) to be settled internally within the network to the largest extend possible, in some embodiments. The bank node 802 can process the transaction internally given that the same central bank 804 stores the funds for the transaction for these customers 806, 808. It is not necessary for bank node 802 to engage the central bank 804 to process the transaction since transaction is internalized. At the level of central bank 804, customer funds can be commingled for bank node 802. The bank node 802 does not have to update or notify central bank 804 to complete this transaction as it can be settled internally.

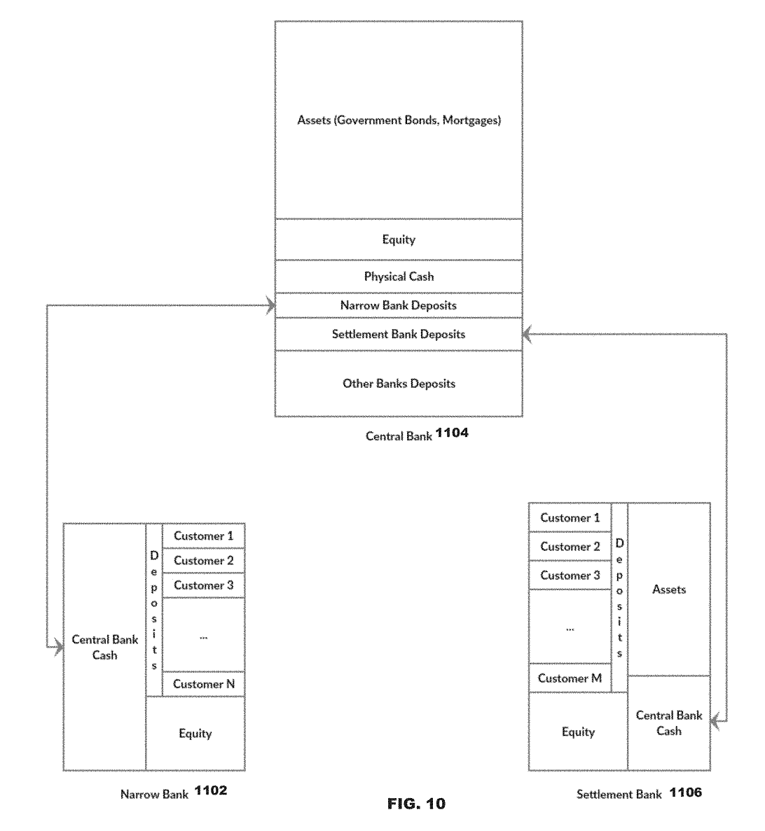

FIG. 10 is a diagram of bank node 1102 connecting to a central-bank 1104 connecting and a settlement bank 1106 according to some embodiments. The settlement bank 1106 can implement a commercial banking settlement and exchange system, for example. The bank node 1102 can be referred to as a narrow bank in view of its narrow or focused functionality for deposits, withdraws and exchanges. Bank node 1102 can transmit messages to central-bank 1104 and settlement bank 1106 to trigger transactions. Account platform 100 can receive the messages regarding the transactions to record the transactions on the distributed ledger using block chain device 320. In some embodiments, bank node 1102 can first transmit a message to account platform 100 which in turn relays it to central-bank 1104 or settlement bank 1106. In some embodiments, bank node 702 can transmit a first message to central-bank and a copy of the first message to account platform 100. In some embodiments, bank node 1102 can transmit a first message to central-bank 1104 or settlement bank 1106 which in turn relays the message to account platform 100. In this way account platform 100 can record transactions between central bank 1104, bank node 1102 or settlement bank 1106. In this example, central bank 1104, settlement bank 1106 and bank node 1102 can be part of the same economy and handle funds in the same currency relating to the same economy. Central-bank 1104 maintains data structures representing assets, equity, physical cash, narrow bank deposits, and other bank deposits. Account platform 100 is operable to maintain a copy of the data structures as part of the distributed ledger using block chain device 320. Bank node 1102 is operable to maintain data structures representing bank node identifiers, customer identifiers, deposit transactions, currency exchange transactions, withdraw transactions, central-bank cash and equity. Settlement bank 1106 is operable to maintain data structures representing bank identifiers, customer identifiers, deposit transactions, assets, equity, and central-bank cash. Bank node 1102 and central-bank 1104 are operable to exchange funds with settlement bank 1106 to process transaction requests.

The bank node 1102 has a central-bank cash component that connects to a narrow bank deposit component of central bank 1104 to exchange funds for transactions. Settlement bank 1106 has a central-bank cash component that connects to a settlement bank deposit component of central-bank 1104 to exchange funds for transactions.

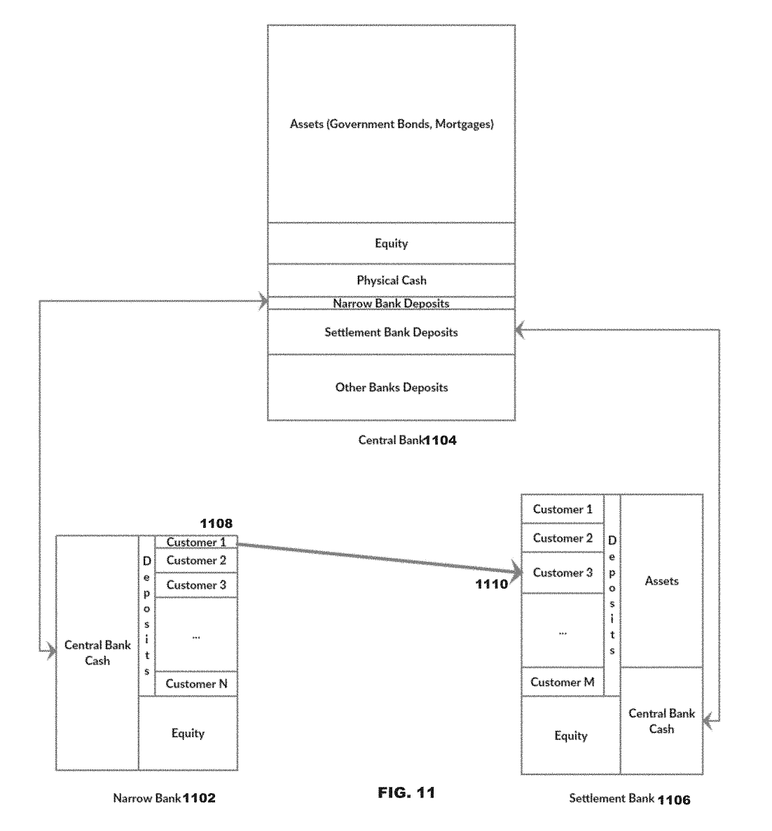

FIG. 11 is a diagram of a central-bank 1104 connecting to a bank node 1102 and a settlement bank 1106 to transfer funds between customers according to some embodiments. Bank node 1102 triggers a transaction between customer 1 1108 and customer 3 1110. Customer 1 1108 of bank node 1102 transfers funds to customer 3 1110 of settlement bank 1106. The settlement bank 1106 manages the account for customer 3 1110. Bank node 1102 transmits a message with the transaction request to central-bank 1104. Bank node 1102 triggers withdraw of funds from an account associated with customer 1 1108 and deposit of the funds within an account associated with customer 3 1110 having an account at settlement bank 1106. Account platform 100 processes the message to record the transaction on the distributed ledger using the block chain device 320. The funds may be in the same currency so that no exchange transaction is required in some embodiments. The distributed ledger creates a block for the withdrawal of funds to maintain an up-to-date record of customer accounts. The bank node 1102 has a central-bank cash component that connects to a narrow bank deposit component of central bank 1104 to exchange funds for transactions. Settlement bank 1106 has a central-bank cash component that connects to a settlement bank deposit component of central-bank 1104 to exchange funds for transactions.

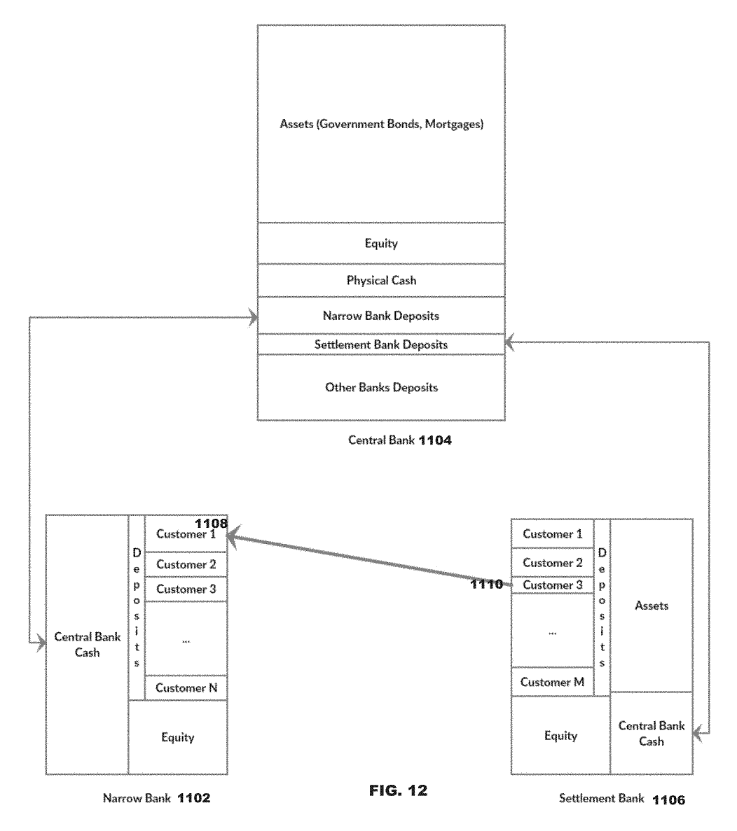

FIG. 12 is a diagram of a central-bank 1104 connecting to a bank node 1102 and a settlement bank 1106 to transfer funds between customers according to some embodiments. Bank node 1102 triggers a transaction between customer 1 1108 and customer 3 1110. Customer 3 1110 of settlement bank 1106 transfers funds to customer 1 1108 of bank node 1102. The settlement bank 1106 manages the account for customer 3 1110. Settlement bank 1106 or Bank node 1102 transmits a message with the transaction request to central-bank 1104. The settlement bank 1106 triggers withdraw of funds from an account associated with customer 3 1110 and deposit of the funds within an account associated with customer 1 1108 having an account at bank node 1102. Account platform 100 processes the message to record the transaction on the distributed ledger using the block chain device 320. The funds may be in the same currency so that no exchange transaction is required in some embodiments. The distributed ledger creates a block for the withdrawal of funds to maintain an up-to-date record of customer accounts. The bank node 1102 has a central-bank cash component that connects to a narrow bank deposit component of central bank 1104 to exchange funds for transactions. Settlement bank 1106 has a central-bank cash component that connects to a settlement bank deposit component of central-bank 1104 to exchange funds for transactions.

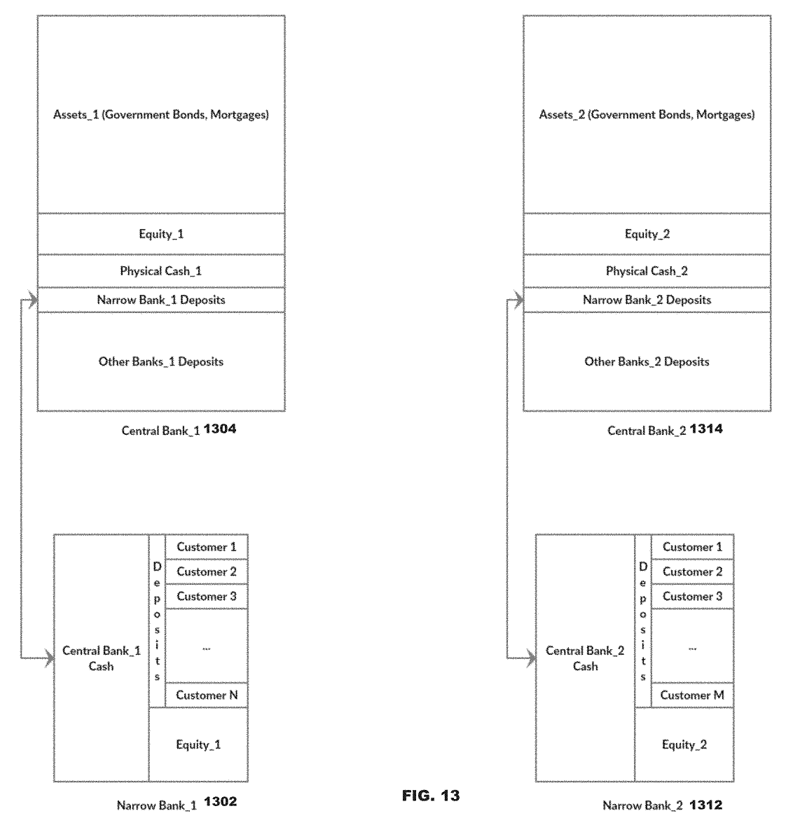

FIG. 13 is a diagram of central banks 1304, 1314 connecting to bank nodes 1302, 1312 according to some embodiments. A central-bank 1304 and a bank node 1302 can be part of one economy and a central-bank 1314 and a bank node 1312 can be part of another economy. For example, the central-bank 1304 can handle funds in one currency and the central-bank 1314 can handle funds in another currency. The bank node 1302 has a central-bank cash component that connects to a narrow bank deposit component of central bank 1304 to exchange funds for transactions. The bank node 1312 has a central-bank cash component that connects to a narrow bank deposit component of central bank 1314 to exchange funds for transactions.

Bank node 1302 can transmit messages to central-bank 1304 to trigger transactions. Account platform 100 can receive the messages regarding the transactions to record the transactions on the distributed ledger using block chain device 320. In some embodiments, bank node 1302 can transmit a message to account platform 100 which in turn relays it to central-bank 1304. In some embodiments, bank node 1302 can transmit a first message to central-bank and a copy of the first message to account platform 100. In some embodiments, bank node 1302 can transmit a first message to central-bank 1304 which in turn relays the message to account platform 100. Account platform 100 can record transactions between central bank 1304 and bank node 1302. In this example, central bank 1304 and bank node 1302 can be part of the same economy and exchange funds in the same currency for that same economy. Central-bank 1304 maintains data structures representing assets, equity, physical cash, narrow bank deposits, and other bank deposits. Account platform 100 is operable to maintain the data structures or a copy of the data structures as part of the distributed ledger using block chain device 320. Bank node 1302 is operable to maintain data structures representing bank node identifiers, customer identifiers, deposit transactions, currency exchange transactions, withdraw transactions, central-bank cash and equity. Bank node 1302 and central-bank 1304 are operable to exchange funds to process transaction requests.

Bank node 1312 can transmit messages to central-bank 1314 to trigger transactions. Account platform 100 can receive the messages regarding the transactions to record the transactions on the distributed ledger using block chain device 320. In some embodiments, bank node 1312 can transmit a message to account platform 100 which in turn relays it to central-bank 1314. In some embodiments, bank node 1312 can transmit a first message to central-bank and a copy of the first message to account platform 100. In some embodiments, bank node 1302 can transmit a first message to central-bank 1314 which in turn relays the message to account platform 100. Account platform 100 can record transactions between central bank 1314 and bank node 1312. In this example, central bank 1314 and bank node 1312 can be part of the same economy and exchange funds in the same currency for that same economy. Central-bank 1314 maintains data structures representing assets, equity, physical cash, narrow bank deposits, and other bank deposits. Account platform 100 is operable to maintain the data structures or a copy of the data structures as part of the distributed ledger using block chain device 320. Bank node 1312 is operable to maintain data structures representing bank node identifiers, customer identifiers, deposit transactions, currency exchange transactions, withdraw transactions, central-bank cash and equity. Bank node 1312 and central-bank 1314 are operable to exchange funds to process transaction requests.

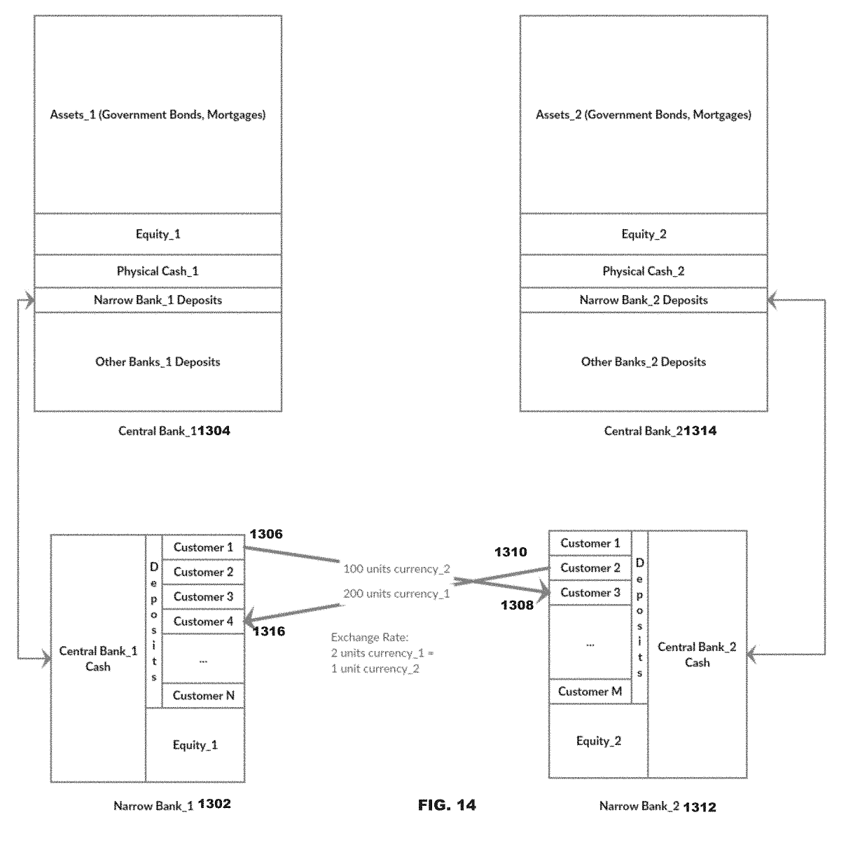

FIG. 14 is a diagram of central banks 1304, 1314 connecting to bank nodes 1302, 1312 to transfer funds between customers 1306, 1308, 1310, 1316 according to some embodiments. Customer 1 1306 of bank node 1302 can trigger a transaction to transfer funds to customer 3 1308 of bank node 1312. The funds can be 100 units of currency 2 for example. Customer 2 1310 of bank node 1312 can trigger a transaction to transfer funds to customer 4 1316 of bank node 1302. The funds can be 200 units of currency 1 for example. Bank node 1302 and bank node 1312 can implement a currency exchange function based on a dynamically determined exchange rate. For example, an exchange rate may specify that two units of currency 1 equal one unit of currency 2.

Bank node 1302 and bank node 1312 triggers a transaction between customer 1 1306 and customer 3 1308 by interacting with central-bank 1304 and central-bank 1314. Bank node 1302 transmits a message with the transaction request to central-bank 1304 to withdraw funds from an account associated with customer 1 1306 and to deposit the funds within an account associated with customer 3 1308. Account platform 100 processes the message to record the transaction on the distributed ledger using the block chain device 320. A currency exchange may be required based on the dynamically determined exchange rate. The distributed ledger creates a block for the withdrawal of funds and a block for the deposit of funds to maintain an up-to-date record of customer accounts. In this example, the transaction can be processed internally and central bank deposits are not required in some embodiments.

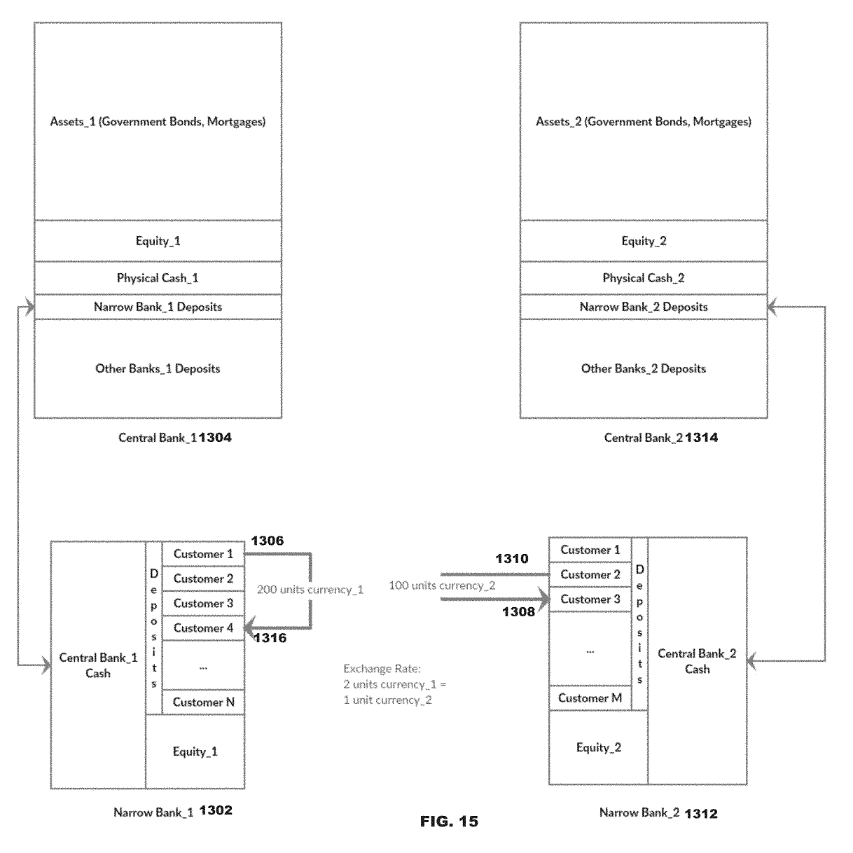

FIG. 15 is a diagram of central banks 1304, 1314 connecting to bank nodes 1302, 1312 to transfer funds between customers 1306, 1308, 1310, 1316 according to some embodiments. In this example, the funds transfer process is internalized to minimize currency exchange. Customer 1 1306 of bank node 1302 triggers of transfer of funds to customer 4 of bank node 1302. The funds can be 200 units of currency 1 for example. Customer 2 of bank node 1312 triggers a transfer of funds to customer 3 of bank node 1312. The funds can be 100 units of currency 2. The distributed ledger creates a block for the withdrawal of funds and a block for the deposit of funds to maintain an up-to-date record of customer accounts. In this example, central banks 1304, 1314 do not need to be involved in processing the transaction as the transaction can be processed internally.

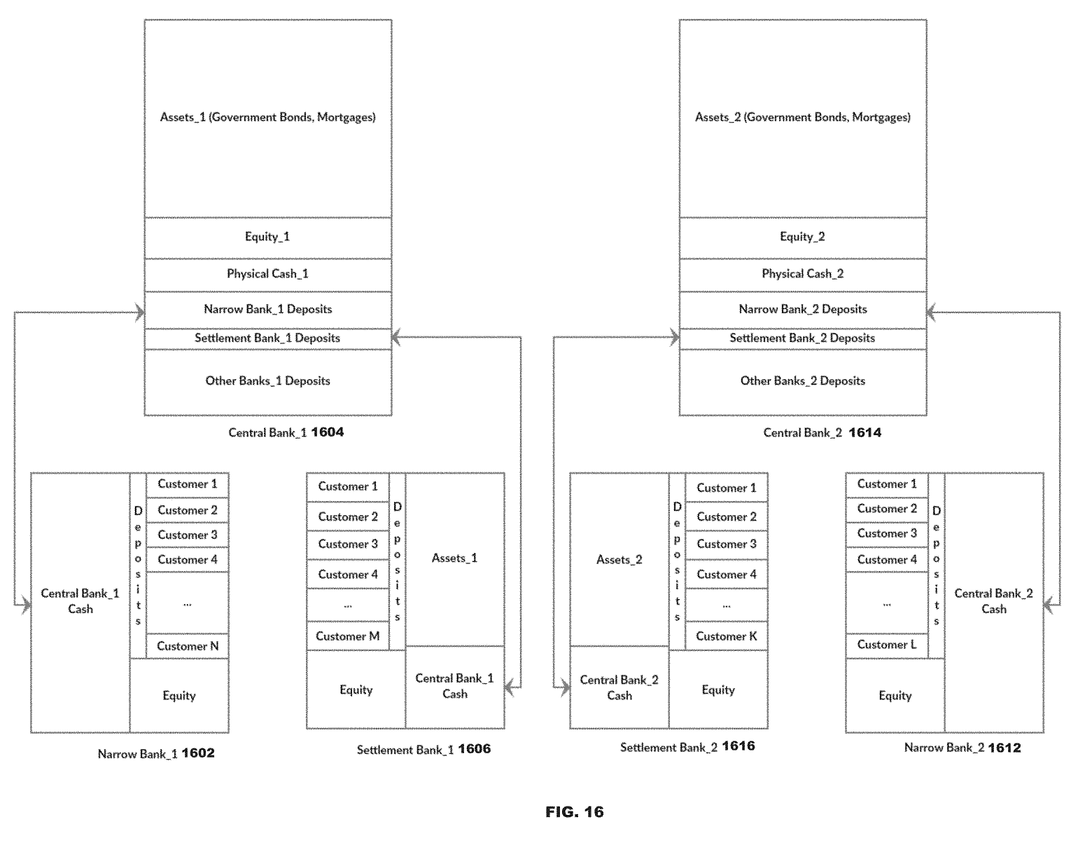

FIG. 16 is a diagram of central banks 1604, 1614 connecting to bank nodes 1602, 1612 and settlement banks 1606, 1616 according to some embodiments. The settlement bank 1606, 1616 can implement a commercial banking settlement and exchange system, for example. A central-bank 1604, settlement banks 1606 and a bank node 1602 can be part of one economy and a central-bank 1314, settlement banks 1616 and a bank node 1312 can be part of another economy. For example, the central-bank 1604 can handle funds in one currency and the central-bank 1614 can handle funds in another currency.

Bank node 1602, 1612 can transmit messages to central-bank 1604, 1614 to trigger transactions. Settlement bank 1606, 1616 can transmit messages to central-bank 1604, 1614 to trigger transactions. Account platform 100 can receive the messages regarding the transactions to record the transactions on the distributed ledger using block chain device 320. In some embodiments, bank node 1602, 1612 can transmit a message to account platform 100 which in turn relays it to central-bank 1604, 1614. In some embodiments, bank node 1602, 1612 can transmit a first message to central-bank 1604, 1614 and a copy of the first message to account platform 100. In some embodiments, bank node 1602, 1612 can transmit a first message to central-bank 1604, 1614 which in turn relays the message to account platform 100.

Account platform 100 can record transactions between central bank 1604, 1614 and bank node 1602, 1612. In this example, central bank 1604 and bank node 1602 can be part of the same economy and exchange funds in the same currency for that same economy. Central bank 1614 and bank node 1612 can be part of the same economy and exchange funds in the same currency for that same economy. Bank node 1602 and central-bank 1604 are operable to exchange funds to process transaction requests. Bank node 1612 and central-bank 1614 are operable to exchange funds to process transaction requests. Settlement bank 1606 and central-bank 1604 are operable to exchange funds to process transaction requests. Settlement bank 1616 and central-bank 1614 are operable to exchange funds to process transaction requests.

Central-bank 1604, 1614 maintains data structures representing assets, equity, physical cash, narrow bank deposits, and other bank deposits. Account platform 100 is operable to maintain the data structures or a copy of the data structures as part of the distributed ledger using block chain device 320. Bank node 1602, 1612 is operable to maintain data structures representing bank node identifiers, customer identifiers, deposit transactions, currency exchange transactions, withdraw transactions, central-bank cash and equity. The bank node 1602 has a central-bank cash component that connects to a narrow bank deposit component of central bank 1604 to exchange funds for transactions. The bank node 1612 has a central-bank cash component that connects to a narrow bank deposit component of central bank 1614 to exchange funds for transactions. The settlement bank 1606 has a central-bank cash component that connects to a settlement bank deposit component of central-bank 1604. Settlement bank 1616 has a central-bank cash component that connects to a settlement bank deposit component of central-bank 1614 to exchange funds for transactions.

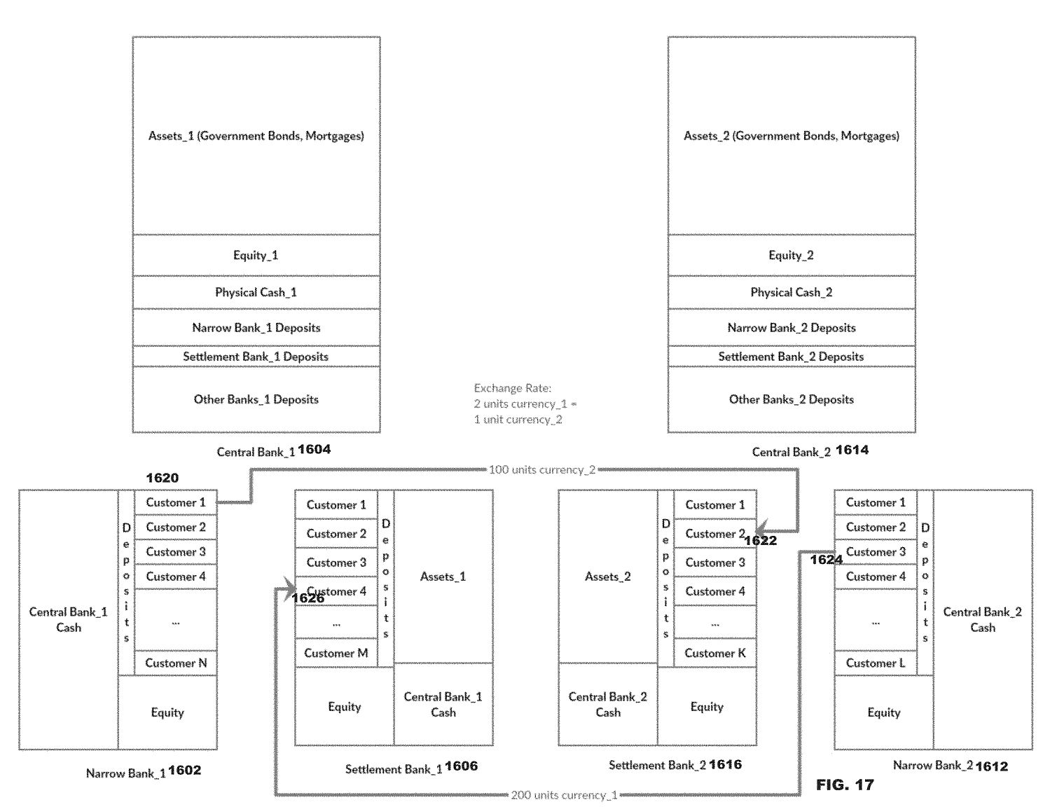

FIG. 17 is a diagram of central banks 1604, 1614 connecting to bank nodes 1602, 1612 and settlement banks 1606, 1616 to transfer funds between customers 1620, 1622, 1624, 1626 according to some embodiments. Customer 1 1620 of bank node 1602 can trigger a transaction to transfer funds to customer 2 1622 of settlement bank 1616. The funds can be 100 units of currency 2 for example. Customer 3 of bank node 1612 can trigger a transaction to transfer funds to customer 4 of settlement bank 1606. The funds can be 200 units of currency 1 for example. Bank node 1602 and bank node 1612 can implement a currency exchange function based on a dynamically determined exchange rate. For example, an exchange rate may specify that two units of currency 1 equal one unit of currency 2.

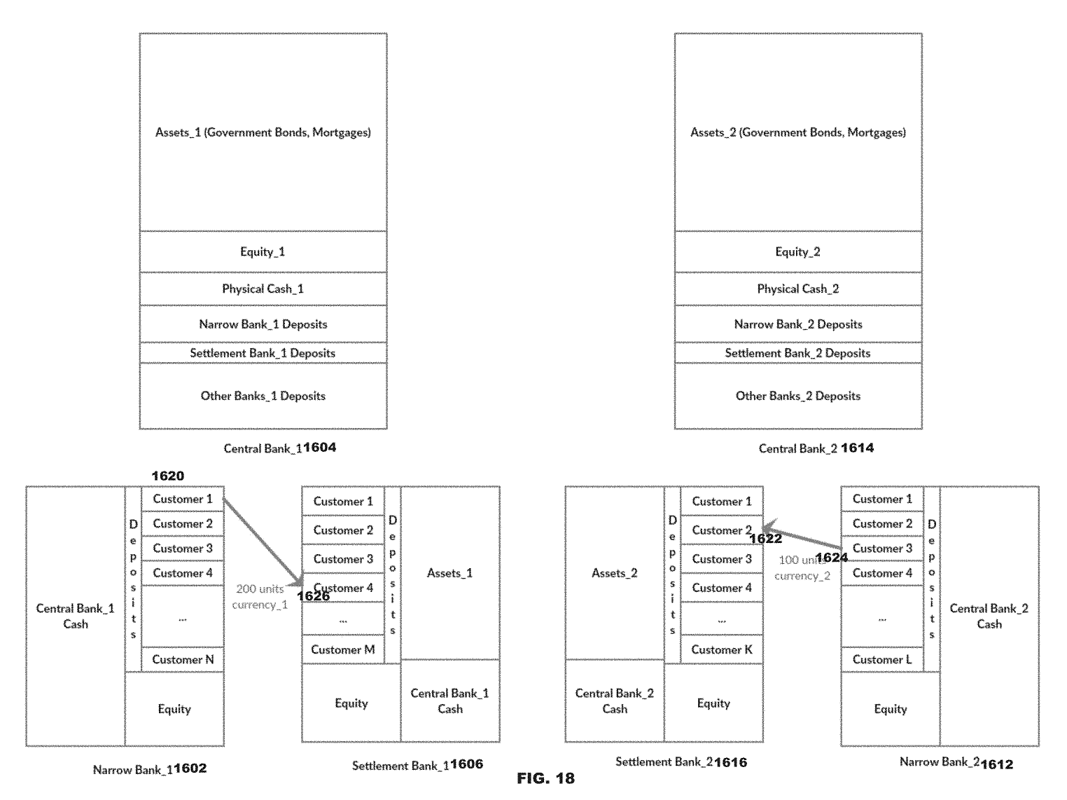

FIG. 18 is a diagram of central banks 1604, 1614 connecting to bank nodes 1602, 1612 and settlement banks 1606, 1616 to transfer funds between customers 1620, 1622, 1624, 1626 according to some embodiments. In this example, the funds transfer process is internalized to minimize currency exchange. Customer 1 1620 of bank node 1602 triggers the transfer of funds to customer 4 1626 of settlement banks 1606. The funds can be 200 units of currency 1 for example. The bank node 1602 and the settlement bank 1606 interact with central-bank 1604 to implement the transfer funds. Customer 3 1624 of bank node 1612 triggers the transfer of funds to customer 2 1622 of settlement bank 1616. The funds can be 100 units of currency 2 for example. Settlement bank 1616 and bank node 1612 interact with central-bank 1614 to implement the transfers of funds.

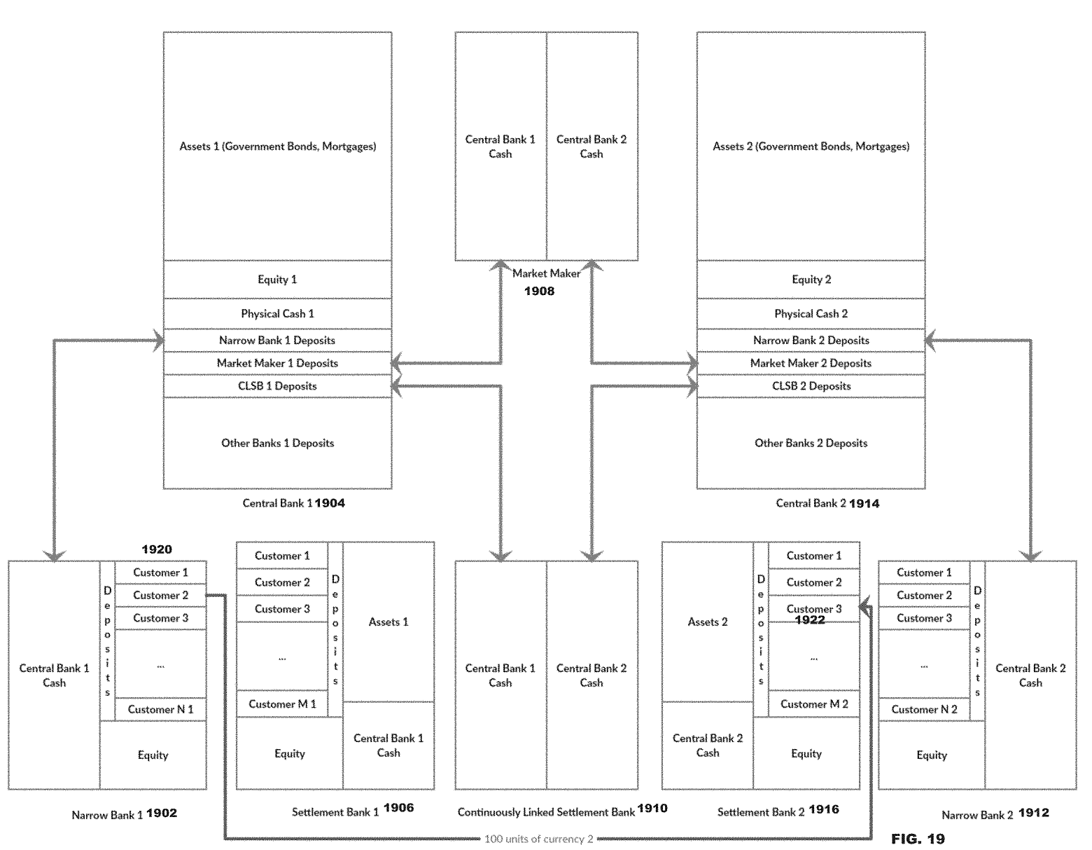

FIG. 19 is a diagram of central banks 1904, 1914 connecting to bank nodes 1902, 1912 and settlement banks 1906, 1916 to transfer funds between customers according to some embodiments. The settlement bank 1906, 1916 can implement a commercial banking settlement and exchange system, for example. A central-bank 1904, settlement banks 1906 and a bank node 1902 can be part of one economy and a central-bank 1914, settlement banks 1916 and a bank node 1912 can be part of another economy. For example, the central-bank 1904 can handle funds in one currency and the central-bank 1914 can handle funds in another currency. Customer 2 1920 of bank node 1902 triggers transfer of funds to customer 3 1922 of settlement bank 1916. The funds can be 100 units of currency 2. There is no offsetting payment in this example.

Bank node 1902, 1912 can transmit messages to central-bank 1904, 1914 to trigger transactions. Settlement bank 1906, 1916 can transmit messages to central-bank 1904, 1914 to trigger transactions. Account platform 100 can receive the messages regarding the transactions to record the transactions on the distributed ledger using block chain device 320. In some embodiments, bank node 1902, 1912 can transmit a message to account platform 100 which in turn relays it to central-bank 1904, 1914. In some embodiments, bank node 1902, 1912 can transmit a first message to central-bank 1904, 1914 and a copy of the first message to account platform 100. In some embodiments, bank node 1902, 1912 can transmit a first message to central-bank 1904, 1914 which in turn relays the message to account platform 100. Account platform 100 can record transactions between central bank 1904, 1914 and bank node 1902, 1912. In this example, central bank 1904 and bank node 1902 can be part of the same economy and exchange funds in the same currency for that same economy. Central bank 1914 and bank node 1912 can be part of the same economy and exchange funds in the same currency for that same economy. Bank node 1902 and central-bank 1904 are operable to exchange funds to process transaction requests. Bank node 1912 and central-bank 1914 are operable to exchange funds to process transaction requests. Settlement bank 1906 and central-bank 1904 are operable to exchange funds to process transaction requests. Settlement bank 1916 and central-bank 1914 are operable to exchange funds to process transaction requests.

Central-bank 1904, 1914 maintains data structures representing components such as assets, equity, physical cash, narrow bank deposits, and other bank deposits. Account platform 100 is operable to maintain the data structures or a copy of the data structures as part of the distributed ledger using block chain device 320. Bank node 1902, 1912 is operable to maintain data structures representing components such as bank node identifiers, customer identifiers, deposit transactions, currency exchange transactions, withdraw transactions, central-bank cash and equity. Settlement bank 1906, 1916 is operable to maintain data structures representing components such as central bank case, assets, customer accounts, and equity.

The bank node 1902 has a central-bank cash component that connects to a narrow bank deposit component of central bank 1904 to exchange funds for transactions. The bank node 1912 has a central-bank cash component that connects to a narrow bank deposit component of central bank 1914 to exchange funds for transactions. The settlement bank 1906 has a central-bank cash component that connects to a settlement bank deposit component of central-bank 1904. Settlement bank 1916 has a central-bank cash component that connects to a settlement bank deposit component of central-bank 1614 to exchange funds for transactions. Account platform 100 records the transactions on the distributed ledger using block chain device 320.

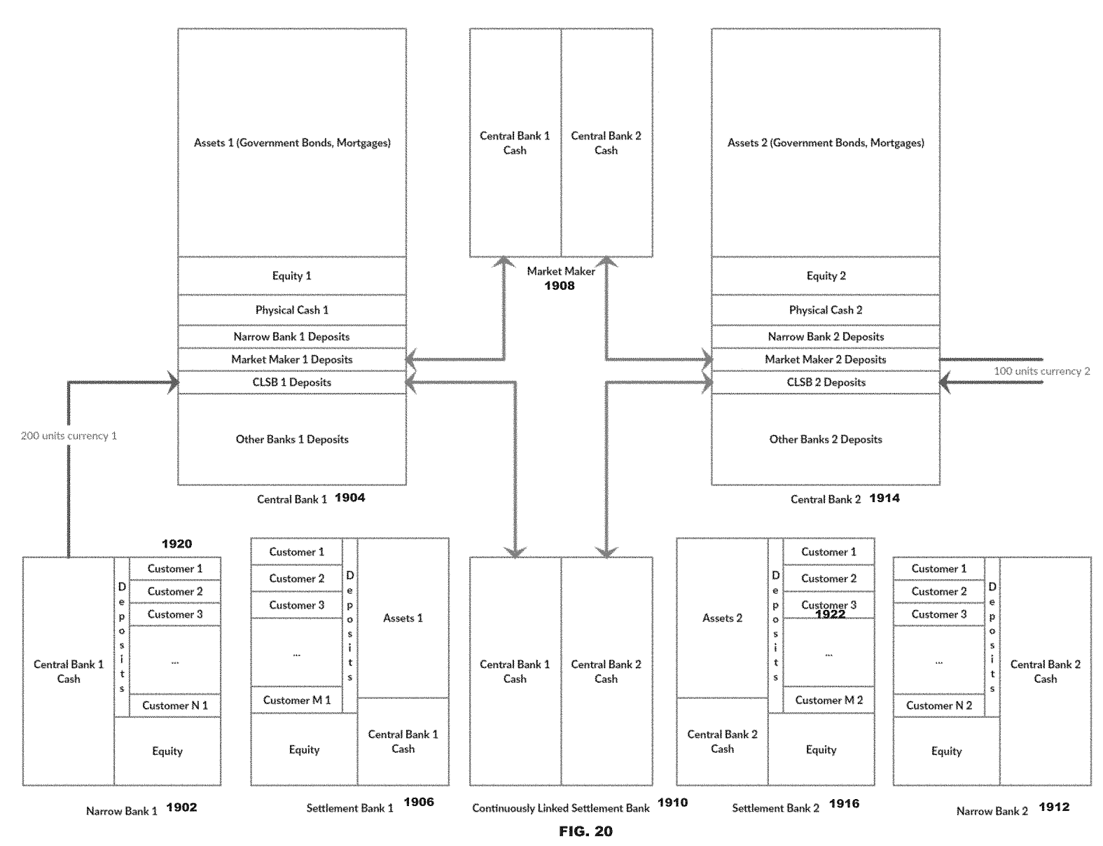

FIG. 20 is a diagram of central banks 1904, 1914 connecting to bank nodes 1902, 1912, settlement banks 1906, 1916, continuously linked settlement bank 1910 and market makers 1908 to transfer funds between customers according to some embodiments. Bank node 1902 uses the services of market maker 1908 and the continuously linked settlement bank 1910. This may avoid issues related to possible default of the market maker 1908. Bank node 1902 transfers funds (200 units of currency 1) to continuously linked settlement bank 1910. Market maker 1908 transfer funds (100 units of currency 2) to continuously linked settlement bank 1910. The deposit of customer 2 1920 can be reduced by 200 units of currency 1 in this example. Account platform 100 records the transactions on the distributed ledger using block chain device 320.

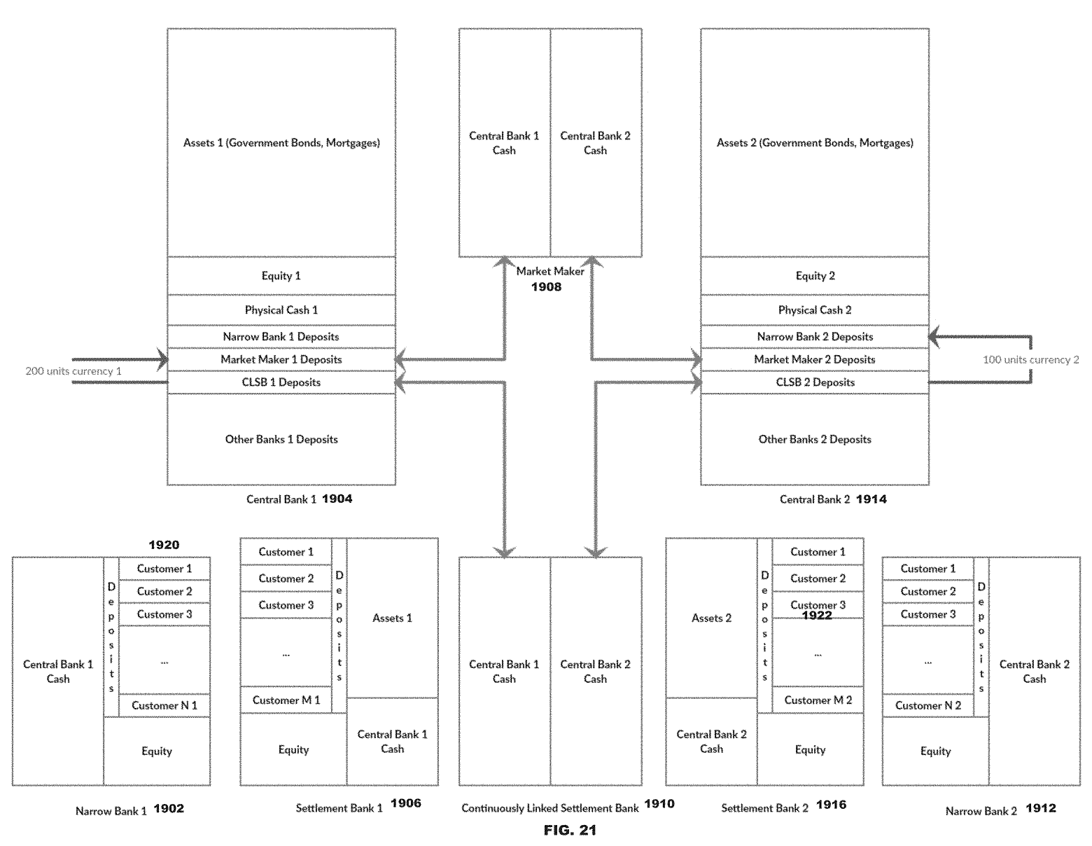

FIG. 21 is a diagram of central banks 1904, 1914 connecting to bank nodes 1902, 1912, settlement banks 1906, 1916, continuously linked settlement bank 1910 and market maker 1908 to transfer funds between customers according to some embodiments. Upon receiving funds from both parties, the continuously linked settlement bank 1910 triggers transfer of funds (200 units of currency 1) to market maker 1908 and funds (100 units of currency 2) to bank node 1902. Counterparty risk can be reduced. Account platform 100 records the transactions on the distributed ledger using block chain device 320.

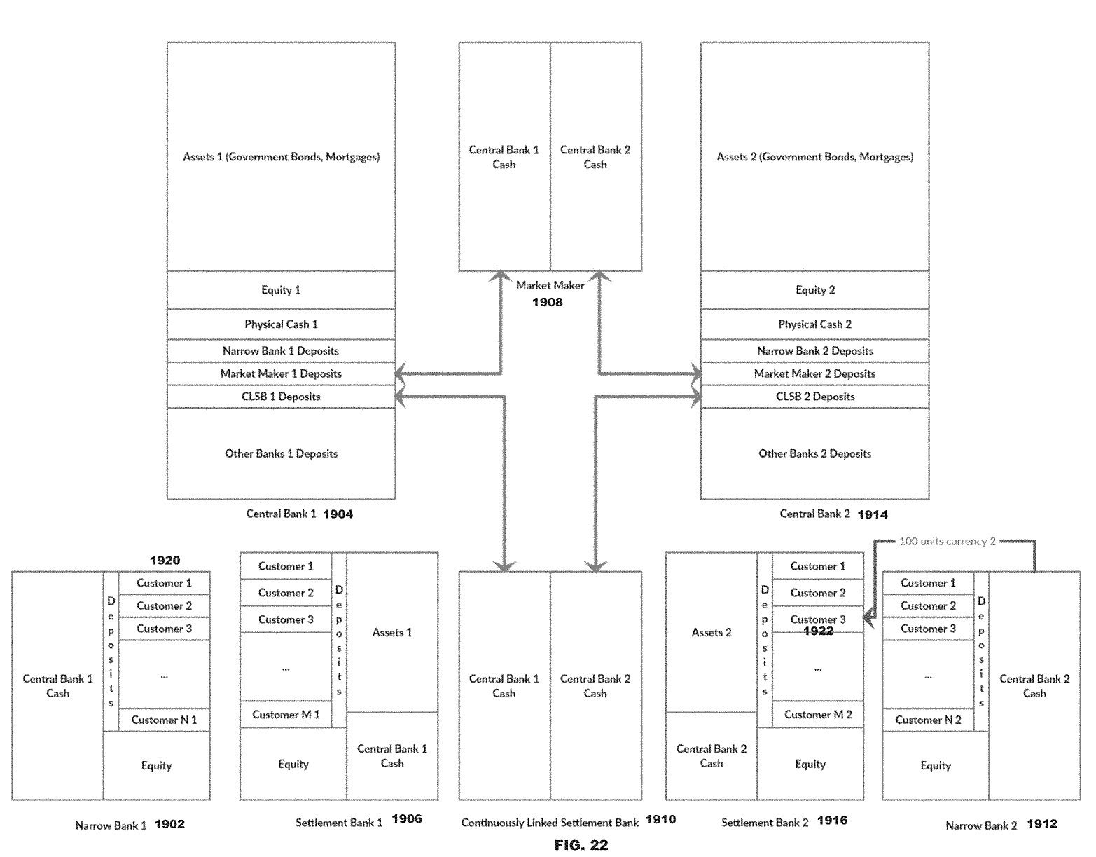

FIG. 22 is a diagram of central banks 1904, 1914 connecting to bank nodes 1902, 1912, settlement banks 1906, 1916, continuously linked settlement bank 1910 and market maker 1908 to transfer funds between customers according to some embodiments. Upon receiving funds (100 units of currency 2), bank node 1902 transfers the fund to an account for customer 3 1922 of settlement bank 1916. Counter party risk is reduced. Account platform 100 records the transactions on the distributed ledger using block chain device 320.

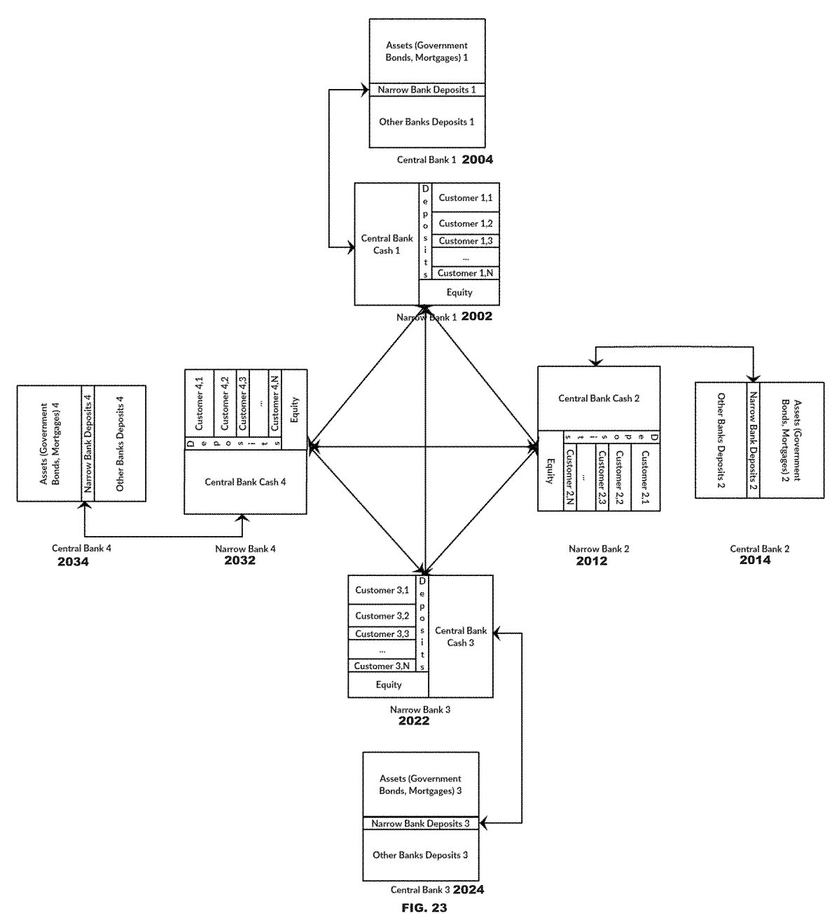

FIG. 23 is a diagram of central banks 2004, 2012, 2024, 2034 connecting to bank nodes 2002, 2012, 2022, 2032 to transfer funds between customers according to some embodiments. The bank nodes 2002, 2012, 2022, 2032 have central bank cash accounts to deposit and withdraw funds in central banks 2004, 2012, 2024, 2034 on behalf of customers. The bank nodes 2002, 2012, 2022, 2032 exchange data to transfer funds between central banks 2004, 2012, 2024, 2034.

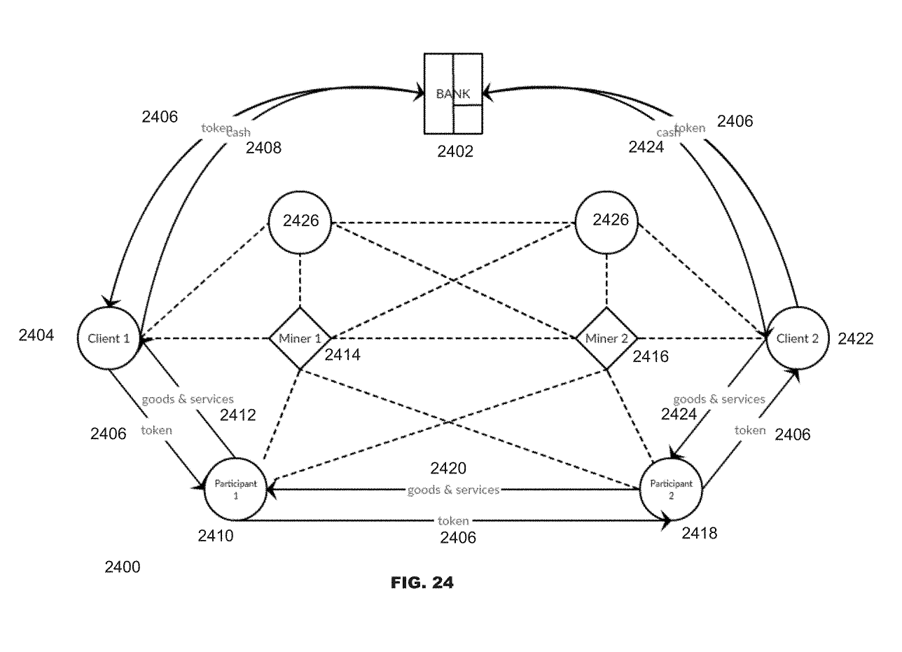

FIG. 24 is a diagram of a bank node (referred to as a narrow bank 2402) with a cryptocurrency application 2402.

In some embodiments, a narrow bank 2402 is a natural vehicle for issuing a stable fiat-backed cryptocurrency, which can be viewed as a digital version of cash.

In an example setting, a client delivers fiat currency into the narrow bank either from their existing account with the narrow bank or via a wire-transfer from another bank. In the former case, the bank already knows the client and does not need to conduct identification due diligence. In the latter case, the bank performs the necessary know your customer identification process. In return, the client receives digital tokens. The bank 2402 deposits the funds with the central bank.

The client can use their tokens to transfer value on a distributed ledger or blockchain. The token circulates on the distributed ledger until the moment in time when its then owner decides to convert it into fiat currency. The distributed ledger can be designed according to several different specification with consensus maintained either by proof of work, or by proof of stake, or by third party notaries.

The owner returns their token to the bank 2402, which either credits their existing account or wires the funds to an account in a different bank by transferring some of its central bank cash to this bank. In the former case, the bank knows the client already. In the latter case, the bank performs the necessary know your customer steps.

The tokens retain their value in a narrow band around par by virtue of arbitrage. In a case when the price of the token falls significantly below par, its owner can immediately give it back to the bank and receive the full value. In a case when the price of the token increases significantly above par, the bank can issue more tokens into the ledger, thus reducing their price, either by using its own capital or by attracting outside investors.

In FIG. 24, at time T1 the narrow bank 2402 issues a digital token 2406 to Client1 2404 in exchange for fiat currency 2408, which is either coming from the Client1 2404 account with the bank 2402 or wired from an account with a different bank. At time T2, Client1 2404 passes this token to Participant12410 in exchange for goods and services 2412. The act of ownership transfer is recorded on a distributed ledger 2426, whose integrity is maintained by Miner1 2414 and Miner2 2416 (of many). At time T3, Participant12410 passes the token 2406 to Participant2 2418 in exchange for goods and services 2420. At time T4, Participant2 2418 passes the token 2406 to Client2 2422 in exchange for goods and services 2424. Finally, at time T5, Client2 2422 passes the token 2406 to the narrow bank 2402 in exchange for fiat currency 2424, which is either deposited in the Client2 2422 account with the narrow bank 2402 or wired to the Client2 2422 account with a different bank.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A network comprising:
a plurality of bank nodes, each bank node connected to a corresponding central bank system to transmit fund transfer commands to trigger a transaction exchange;
an account platform having non-transitory computer-readable storage medium with computer-executable instructions for causing a processor to generate transaction data elements and record the transaction data elements on a plurality of ledger nodes, each ledger node comprising at least one computing device, the account platform connecting to the plurality of bank nodes to receive transaction notifications relating to the fund transfer commands, the account platform being configured to maintain and update a distributed ledger by creating block data structures for transactions using the ledger nodes for transaction management, each block data structure indicating a customer identifier for use in generating a dynamic customer record by aggregating block data structures indicating the customer identifier; and
an interface for displaying visual representations corresponding to the dynamic customer record.

2. The network of claim 1, wherein a first bank node of the plurality of bank nodes is configured to:
generate a first fund transfer command indicating a first customer identifier, a second customer identifier, and a transaction amount; and
transmit a transaction notification to the account platform;
wherein the account platform is configured to:
generate a block data structure indicating the first customer identifier, the second customer identifier, and the transaction amount; and
update the distributed ledger with the block data structure to provide notification to the other of the plurality of bank nodes.

3. The network of claim 2 wherein the first bank node is configured to transmit the first fund transfer command to a central bank system to trigger transfer of the transaction amount between an account linked to the first customer identifier and an account linked to the second customer identifier.

4. The network of claim 2 wherein the first bank node is configured to transmit the first fund transfer command to a first central bank system and the account platform, wherein the account platform transmits the first fund transfer command to a second bank node connected to a second central bank system, wherein the first fund transfer command triggers transfer of the transaction amount between an account linked to the first customer identifier managed by the first bank node and an account linked to the second customer identifier manages by the second bank node, wherein the first bank node transfers the transaction amount from the first central bank, wherein the second bank node transfer the transaction amount to the second central bank, wherein the account platform generates the block data structure indicating the first central bank and the second central bank.

5. The network of claim 4 wherein the first bank node and the second bank node are configured to implement a currency exchange component to exchange the transaction amount from a first currency amount to a second currency amount, wherein the account platform generates the block data structure indicating the first currency amount and the second currency amount.

6. The network of claim 2 wherein the first bank node is configured to trigger a transfer of the transaction amount between an account linked to the first customer identifier and an account linked to the second customer identifier for internal settlement, the account linked to the first customer identifier and the account linked to the second customer identifier managed by the first bank node.

7. The network of claim 2 wherein the account platform generates a deposit block data structure for a deposit of the transaction amount to the account linked to the second customer identifier and a withdrawal block data structure for a withdrawal of the transaction amount from the account linked to the first customer identifier, wherein the interface displays visual representations corresponding to a dynamic first customer record and a dynamic second customer record.

8. The network of claim 1 wherein at least one bank node of the plurality of bank nodes is connected to a settlement bank system for transmission of the fund transfer commands.

9. The network of claim 1, wherein a first bank node of the plurality of bank nodes is configured to:
generate a first fund transfer command indicating a first customer identifier, a virtual token identifier, and a transaction amount; and
transmit a transaction notification to the account platform;
wherein the account platform is configured to:
generate a block data structure indicating the first customer identifier, the virtual token identifier, and the transaction amount; and
update the distributed ledger with the block data structure.

10. A non-transitory computer readable medium having computer-executable instructions for causing a processor to:
receive a transaction notification from a bank node connected to a central bank system, the transaction notification indicating a customer identifier and transaction data;
create a block data structure for the transaction notification, the block data structure indicating the customer identifier and the transaction data;
update, with the block data structure, a distributed ledger managed by a plurality of ledger nodes, each ledger node comprising at least one computing device;
generate a customer record by aggregating a set of blocks of the distributed ledger, each block of the set of blocks indicating the customer identifier; and
transmit the customer record to an interface to trigger display of visual elements corresponding to the customer record on a display device.

11. The non-transitory computer readable medium of claim 10 having computer-executable instructions for causing the processor to transmit a fund transfer command to the central bank system, the fund transfer commands indicating the customer identifier and the transaction data.

12. The non-transitory computer readable medium of claim 10 having computer-executable instructions for causing the processor to:
generate a first fund transfer command indicating a first customer identifier, a second customer identifier, and a transaction amount; and
transmit a transaction notification to the account platform;
generate a block data structure indicating the first customer identifier, the second customer identifier, and the transaction amount; and
update the distributed ledger with the block data structure to provide notification to the other of the plurality of bank nodes.

13. The non-transitory computer readable medium of claim 10 having computer-executable instructions for causing the processor to transmit the first fund transfer command to the central bank system to trigger transfer of the transaction amount between an account linked to the first customer identifier and an account linked to the second customer identifier.

14. The non-transitory computer readable medium of claim 10 having computer-executable instructions for causing the processor to transmit the first fund transfer command to a first central bank system and the account platform, transmit the first fund transfer command to a second bank node connected to a second central bank system, wherein the first fund transfer command triggers transfer of the transaction amount between an account linked to the first customer identifier managed by the first bank node and an account linked to the second customer identifier manages by the second bank node, wherein the first bank node transfers the transaction amount from the first central bank, wherein the second bank node transfers the transaction amount to the second central bank, wherein the processor generates the block data structure indicating the first central bank and the second central bank.

15. The non-transitory computer readable medium of claim 10 wherein the first bank node and the second bank node are configured to implement a currency exchange component to exchange the transaction amount from a first currency amount to a second currency amount, wherein the processor generates the block data structure indicating the first currency amount and the second currency amount.

16. The non-transitory computer readable medium of claim 10 having computer-executable instructions for causing the processor to trigger a transfer of the transaction amount between an account linked to the first customer identifier and an account linked to the second customer identifier for internal settlement, the account linked to the first customer identifier and the account linked to the second customer identifier managed by the first bank node.

17. The non-transitory computer readable medium of claim 10 having computer-executable instructions for causing the processor to generate a deposit block data structure for a deposit of the transaction amount to the account linked to the second customer identifier and a withdrawal block data structure for a withdrawal of the transaction amount from the account linked to the first customer identifier, wherein the interface displays visual representations corresponding a dynamic first customer record and a dynamic second customer record.

18. The non-transitory computer readable medium of claim 10 wherein at least one bank node of the plurality of bank nodes is connected to a settlement bank system for transmission of the fund transfer commands.

19. The non-transitory computer readable medium of claim 10 having computer-executable instructions for causing the processor to:
generate a first fund transfer command indicating a first customer identifier, a virtual token identifier, and a transaction amount; and
transmit a transaction notification to the account platform;
generate a block data structure indicating the first customer identifier, the virtual token identifier, and the transaction amount; and
update the distributed ledger with the block data structure.

20. A network of bank nodes to transfer funds to central bank systems, and an account platform to generate data elements of transactions and record the data elements of the transactions on a distributed ledger provided by computing devices, at least one transaction being linked to a customer identifier, the account platform being configured to generate and output dynamic customer records using the distributed ledger in response to receiving the customer identifier, wherein at least one data element is linked to a central bank identifier, wherein the account platform is configured to generate the dynamic customer records using the central bank identifier.
